(19) United States
(12) Patent Application Publication
(10) Pub. No.: US 2007/0131358 A1
(43) Pub. Date: Jun. 14, 2007

(54) Shutter curtain lifting prevention structure in shutter device

(76) Inventors: Shinya Iwasaki, Tokyo (JP); Naoki Yokoi, Nishi-Shinjuku (JP); Takanobu Kuribayashi, Nishi- Shinjuku (JP); Mitsuhiro Yoshida, Nishi- Shinjuku (JP)

Correspondence Address: Ladas & Parry, 5670 Wilshire Boulevard, Suite 2100, Los Angeles, CA, 90036-5679, US

(21) Appl. No.: 10/577,817

(22) PCT Filed: Sep. 28, 2004
(86) PCT No.: PCT/JP04/14191

§ 371 Date: Oct. 26, 2006

(30) Foreign Application Priority Data
Oct. 30, 2003 (JP) 2003-369726
Jan. 29, 2004 (JP) 2004-022060
Jun. 7, 2004 (JP) 2004-168428

(51) Int. Cl. E06B 9/08

(52) U.S. Cl. 160/133

(57) ABSTRACT

A shutter curtain lifting prevention structure comprises a shutter curtain formed by connecting a plurality of slats via an interlock portion in the vertical direction, guide rails standing on both sides of an opening of the construction, and a cutout recess being integrally formed at the guide groove of each guide rail. The cutout recess is formed by horizontally cutting out the interior side plane portion of the front face located above and in the vicinity of the floor surface, such that when a bottom plate of the shutter curtain kept in a shut state is lifted, a connection portion of the bottom plate and the slat, which is opposed to the cutout recess is made engaged by the engaging portion defined by the cutout recess, thus preventing lifting of the shutter curtain.

### FIELD OF THE INVENTION

The present invention relates to a shutter curtain lifting prevention structure, and in particular to a shutter lifting prevention structure for securing a crime prevention effect by blocking a shutter curtain kept in a shut state from being opened when an attempt is made to forcibly lift the shutter from the outside using a tool in a gap between the floor surface and the bottom plate.

### BACKGROUND OF THE INVENTION

Shutters of this type are classified into heavy weight shutters and light weight shutters, and also into electric shutters and manual shutters depending on whether or not a drive device is equipped. However, the major function of a shutter is to secure a crime prevention effect by ensuring a closed state.

Therefore, shutters for securing a crime prevention effect have been proposed in which, while the shutter weight causes no problem in normal opening and closing operation of the shutter, the shutter kept in a closed state is made impossible to lift despite an attempt to lift the shutter from below.

According to Japanese Utility Model Registration No. 2525921, curtain pieces which constitute a shutter curtain are connected to one another using bendable locking members, and a lock prong is attached to a place where the locking member bends. When an attempt is made to lift the shutter kept in a shut state, the lock prong is brought to be engaged by a hook formed on a guide rail, whereby the shutter is blocked from being opened. However, as for this construction, as the lock prong projects toward the guide groove, when the shutter curtain is pressed on its surface by strong wind, the lock prong may be engaged with the hook while the shutter is being opened or closed. This causes a problem that the shutter opening and closing operation becomes impossible. Moreover, there is another problem that a crime prevention effect by blocking lifting of a closed curtain cannot be achieved unless the shutter curtain is manufactured in some way.

The object of the present invention to provide a shutter curtain lifting prevention structure for a shutter device, which is employed in a shutter in which a shutter curtain comprising a plurality of curtain pieces connected in the vertical direction are guided for ascending and descending along a guide rail to thereby open and close an opening section, has a simple structure without the need to worry about breakdown, and can significantly improve crime prevention characteristics against lifting of the shutter curtain kept in a closed state.

### DISCLOSURE OF THE INVENTION

A first technical means employed by the present invention is a shutter lifting prevention structure in which, in a shutter in which a plurality of curtain pieces are connected in a bendable manner to thereby constitute a shutter curtain and the edges of the shutter curtain are guided for ascending and descending along the guide rails to thereby open and close an opening section, an engaging portion is provided on the guide rail so as not to block normal opening and closing of the shutter, and when the shutter curtain kept in a shut state is lifted from the lower surface of the bottom plate, one or more curtain pieces of at least a part of the shutter curtain in a vertical posture are bent, whereby a part of the bent curtain piece is caused to be engaged by the engaging portion. According to one aspect, the curtain piece is a slat, and a plurality of slats are connected via an interlock portion to constitute a shutter curtain. The part of the curtain piece which is engaged by the engagement portion is an interlock portion. Further, according to one preferred aspect, the interlock portion which is engaged by the engagement portion is an interlock portion for connecting the bottom plate and the slat. The engaging portion is a cutout recess formed in an interior side portion of the guide rail in the vicinity of the floor surface. According to another preferred aspect, the engaging portion provided on the guide rail is an engaging prong which is formed so as not to project toward the guide groove, on at least the interior side wall of hardware provided on the inner or outer side of the guide rail. Pressing by the bent curtain piece causes the interior or exterior side wall of the guide rail to expand, thus causing the curtain piece to be engaged by the engaging prong.

A second technical means employed by the present invention is characterized in that, in a shutter device in which both edges of a shutter curtain which is formed by connecting a plurality of slats via an interlock portion in the vertical direction are guided for ascending and descending by the guide rails which stand on the both sides of the opening of the construction, to thereby open and close the opening section of the construction, a cutout recess which is formed by horizontally cutting out the interior side plane portion of the front face located above and in the vicinity of the floor surface, is integrally formed on the guide groove of each guide rail, and when the bottom plate of the shutter curtain kept in a shut state is lifted, the connection of the bottom plate and the slat, which is opposed to the cutout recess is made engaged by the engaging portion formed by the cutout recess, thus preventing lifting of the shutter curtain.

A third technical means employed by the present invention is characterized in that, in a shutter device in which both edges of a shutter curtain which is formed by connecting a plurality of slats via an interlock portion in the vertical direction are guided for ascending and descending by the guide rails which stand on the both sides of the opening of the construction, to thereby open and close the opening section of the construction, the guide groove of the guide rail is formed between the interior side plane portion and exterior side plane portion of each guide rail, an interior side cutout recess having an engagement portion located at a position higher than the connection portion of the bottom plate and the slat of the shutter curtain kept in a fully closed state is formed on the interior side plane portion, and when the bottom plate of the shutter curtain kept in a fully closed state is lifted from the exterior side, the bottom plate inclines and the connection portion is thereby caused to be engaged by the engaging portion of the interior side cutout recess, thus preventing lifting of the shutter curtain.

In the third technical means, according to a preferred aspect, an exterior side cutout recess is formed on the exterior side plane portion so as to be opposed to the bottom plate of the shutter curtain kept in a fully closed state. When the bottom plate of the shutter curtain kept in a fully closed state is lifted from the exterior side, the bottom plate inclines with the lower end side thereof moving toward the exterior side via the exterior side cutout recess, and the connection portion is thereby caused to be engaged with the engagement portion of the interior side cutout recess, thus preventing lifting of the shutter curtain.

A fourth technical means employed by the present invention is constructed such that, in a shutter device in which both edges of a shutter curtain which is formed by connecting a plurality of slats via an interlock portion in the vertical direction are guided for ascending and descending by the guide rails standing on both sides of the opening of the construction, to thereby open and close the opening section of the construction, the guide groove of the guide rail is formed between the interior side plane portion and exterior side plane portion of each guide rail, the inner space of the guide rail is defined by a guide groove for receiving an end portion of the shutter curtain, an interior side space of the guide groove, and an exterior side space of the guide groove. Further, in the interior side space of the inner space of the guide rail, an intra-rail hook member having an engaging portion located at a position higher than the position of the connection portion of the bottom plate and slat of the shutter curtain kept in fully closed state is formed. On the interior side plane portion of the guide rail, an interior side cutout recess which contains a portion opposed to the engaging portion of the intra-rail hook member is formed, so that when the bottom plate of the shutter certain kept in a fully closed state is lifted from the exterior side, the bottom plate inclines and the connection portion is thereby caused to be engaged by the engaging portion of the intra-rail hook member, thus preventing lifting of the shutter curtain.

In the fourth technical means, according to a preferred aspect, on the exterior side plane portion of the guide rail, an exterior side cutout recess which contains a portion opposed to the bottom plate of the shutter curtain kept in a fully closed state is formed. When the bottom plate of the shutter curtain kept in a fully closed state is lifted from the exterior side, the bottom plate inclines with the lower end side thereof moving toward the exterior side via the exterior side cutout recess, and the connection portion is thereby caused to be engaged by the engagement portion, thus preventing lifting of the shutter curtain.

In the fourth technical means, according to a preferred aspect, the intra-rail hook member is an inner guide rail provided inside the guide rail (in the embodiments described later, a normal guide rail is referred to as an outer guide rail in order to discriminate from an inner guide rail). The guide groove of the inner guide rail is formed by the interior side plane portion and exterior side plane portion of the inner guide rail. On the interior side plane portion of the inner guide rail, an interior side cutout recess having an upper edge located at a position higher than the interlock portion of the slat located directly above the bottom plate of the shutter curtain kept in a fully closed state is formed, and the upper edge constitutes an engaging portion. Also, according to one preferred aspect, an exterior side cutout recess which contains a portion opposed to the bottom plate of the shutter curtain kept in a fully closed state is formed on the exterior side plane portion of the guide rail. Further, on the exterior side plane portion of the inner guide rail, an exterior side cutout recess is formed so as to be opposed to the bottom plate of the shutter curtain kept in a fully closed state. Further, when the intra-rail hook member is made using a member having a U shape in a cross sectional view, as in the embodiment described later, the wall of the lower portion of the guide rail is constructed to have a dual structure, which is more effective against forced entry.

In the above-described technical means, preferably, the cutout recess formed on the guide rail is provided with a cover to close the cutout recess. When only the interior side cutout recess is formed on the guide rail, the cover is provided so as to close the interior side cutout recess. When not only an interior side cutout recess but also an exterior side cutout recess is formed on the guide rail, preferably, an interior side cover and an exterior side cover are provided so as to close the interior side cutout recess and the exterior side cutout recess, respectively. In a normal ascending and descending operation of the shutter curtain, the interior side cover prevents the bottom plate from inclining so that the connection portion of the bottom plate and the slat does not fit into the cutout recess. When the bottom plate of the shutter curtain kept in a fully closed state is lifted from the exterior side, the bottom plate inclines while pressing, and thereby deforming or rotating, the cover, whereby the connection portion is caused to be engaged by the cutout recess. With the one having both of the exterior side cover and interior side cover, the guide groove in the lower portion of the outer guide rail is defined by each cover. In a normal ascending and descending of the shutter curtain, the interior side cover prevents the bottom plate from inclining so that the connection portion of the bottom plate and the slat does not fit into the interior side cutout recess, and the exterior side cover prevents the lower end side of the bottom plate from going into the exterior side cutout recess. When the bottom plate is lifted from the exterior side of the shutter curtain kept in a fully closed state, the bottom plate inclines or rotates while pressing, and thereby deforming, the cover, as a result of which the connection portion is caused to be engaged with the cutout recess.

According to one preferred embodiment, the cover which closes the cutout recess is deformable, and constructed such that when the bottom plate of the shutter curtain kept in a fully closed state is lifted from the exterior side, the connection portion presses, and thereby deforms, the interior side cover to thereby cause the connection portion to be engaged by the engagement portion. With the structure having a deformable interior side cover and a deformable exterior side cover, when the bottom plate of the shutter curtain kept in a closed state is lifted from the exterior side, the lower end side of the bottom plate moves to the exterior side while pressing and deforming the exterior side cover and consequently inclines, so that the connection portion presses, and thereby deforms, the cover of the interior side cutout recess, as a result of which the connection portion is caused to be engaged by the engagement portion.

As a more specific aspect of a deformable cover, a plastically deformable cover and an elastically deformable cover are referred to as examples. With one in which a plastically deformable cover is provided to the cutout recess of the guide rail to cover the cutout recess, when the connection portion (an interlock portion located directly above the bottom plate and opposed to the cutout recess) abuts on the cover of the cutout recess as the bottom plate of the shutter curtain kept in a fully closed state is lifted, and the cover is plastically deformed in the direction of being pressed, as a result of which the connection portion (the interlock portion) is caused to be engaged by the cutout recess. The example in which an elastically deformable cover is provided at the cutout recess of the guide rail to cover the cutout recess is constructed such that, when the connection portion (an interlock portion located directly above the bottom plate and opposed to the cutout recess) presses the cover of the cutout recess as the bottom plate of the shutter curtain kept in a fully closed state is lifted, the cover is elastically deformed in the direction of being pressed, as a result of which the connection portion (the interlock portion) is caused to be engaged by the cutout recess, and when the lifting of the bottom plate is released, the cover which is elastically deformed in the direction of being pressed restores its original predetermined formation.

According to another preferred aspect of the cover, the cover which closes the cutout recess is rotatable, and is constructed such that when the bottom plate of the shutter curtain kept in a fully closed state is lifted from the exterior side, the connection portion presses, and thereby rotates, the cover of the cutout recess to thereby cause the connection portion to be engaged by the engagement portion. The example having a rotatable interior side cover and a rotatable exterior side cover is constructed such that when the bottom plate of the shutter curtain kept in a state of fully closed is lifted from the exterior side, the lower end side of the bottom plate moves toward the exterior side while pressing, and thereby rotating, the exterior side cover and consequently inclines, so that the connection portion presses, and thereby deforms, the cover of the interior side cutout recess, as a result of which the connection portion is caused to be engaged by the engagement portion.

According to one aspect, in the technical means having a cover, the cutout recess has a detection portion formed in the vicinity thereof, for detecting deformation or rotation of the cover.

In this specification, “an exterior side plane portion” and “an interior side plane portion” of a guide rail contain not only a plane portion which extends in a depth direction (7a, 7b in the embodiment to be described later), but also a portion which extends from an end of the plane in a depth direction toward the inside of the guide rail and defines an insertion opening for the end portion of the shutter curtain (7a′, 7b′ in the embodiment to be described later). Also, the “connection portion of the bottom plate and the slat” to be engaged by the engagement portion contains a projection located on the connection portion and formed on the upper portion of the bottom plate.

Still other technical means employed by the present invention is a shutter lifting prevention structure, in which, in a shutter in which a plurality of curtain pieces are connected in a bendable manner to constitute a shutter curtain, and the edges of the shutter curtain are guided for ascending and descending along the guide rails to thereby open and close an opening section, hardware is provided on the inner or outer side of the guide rail, an engagement prong is formed at least on the interior side lateral wall of the hardware so as not to project into the guide groove, and when the shutter curtain is lifted from the lower surface of the bottom plate while the shutter is kept shut, the curtain pieces which are caused to be bent in association with the lifting press to thereby cause the interior side or exterior side lateral wall of the guide rail to expand, and as a result the curtain piece is caused to be engaged by the engagement prong. According to one preferred aspect, the curtain piece to be engaged by the engagement prong of the hardware is an interlock portion connecting the slat.

Therefore, according to the present invention, when the shutter curtain is lifted from an exterior side from the lower surface of the bottom plate using a tool when the shutter device is kept in a shut state, the connection portion of the bottom plate and the slat, which is bent in association with the lifting, is rigidly engaged by the engaging portion of the cutout recess on the guide rail side, thus making it possible to prevent lifting of the shutter curtain. Moreover, as an interlock portion of a slat which forms a conventional shutter curtain is utilized intact as a structural member for lifting prevention, it is possible to constitute a lifting prevention structure which has the above described effect for a lower cost, requiring only easy and small change on the guide rail side but not the need to change a basic structure of a shutter curtain. Also, even if the shutter curtain kept in a fully closed state moves in the direction of the width of the opening section due to an external force, the connection portion (an interlock portion) of both ends of the curtain which are inserted into the guide rail are reliably engaged by the cutout recess of the guide rail. Accordingly, stable crime prevention function can be achieved.

With the structure in which an exterior side cutout recess is formed on the exterior side plane portion of the guide rail so as to be opposed to the bottom plate of the shutter curtain kept in a fully closed state, when the bottom plate of the shutter curtain kept in a fully closed state is lifted, the lower end side of the bottom plate moves to the exterior side via the exterior side cutout recess, and the bottom plate is thereby reliably inclined, so that the connection portion of the bottom plate and the slat is preferably engaged with the upper edge of the interior side cutout recess, making it possible to prevent lifting of the shutter curtain. By providing a space on the exterior side plane portion of the guide rail so as to allow the lower end side of the bottom plate to move to the exterior side, a large distance for movement of the lower end side of the bottom plate toward the exterior side can be ensured, compared to the one which has a cutout recess provided only on the interior side (in which, the lower end side of the inclining bottom plate abuts on the exterior side plane of the guide rail, and further inclination is restricted). This can realize a larger inclination of the bottom plate, and rigid engagement by the interior side cutout recess. In particular, when the interior side cutout recess cannot have a larger width (for example, a guide rail of a light weight shutter), provision of an exterior side cutout recess advantageously enables rigid engagement of the connection of the bottom plate and the slat by the engaging portion, while the bottom plate is kept in an inclined state.

With a structure in which a cover for closing the above-described cutout recess is provided, as the cover serves as a cosmetic cover in normal opening and closing operation of the shutter curtain, entry of foreign matter or dust into the cutout recess can be prevented. Moreover, even if the lower end of the shutter curtain moves slightly in the forward or backward direction relative to the opening, as the cover closes cutout recess, the interlock portion is not unnecessarily hooked by the cutout recess.

In the case where the above-described cover is made as a plastically deformable cover, even if intrusion into the inside of the construction does not succeed when an attempt is made to lift the shutter curtain from the lower surface of the bottom plate, sign of the intrusion is left in the form of plastic deformation of the cover. This can bring the matter to the attention of the construction manager or person concerned for crime prevention.

Meanwhile, in the case where the above-described cover is made elastically deformable, even if the shutter curtain is lifted from the lower surface of the bottom plate, when the bottom plate restores to its normal state in which the bottom plate is placed on the floor surface, the cover is also restored to its own predetermined position. This allows normal opening and closing of the shutter curtain without any change in appearance.

As for the structure equipped with a rotatable cover to close the cutout recess, the entirety of the cover expands more toward the interior side, compared to the case using a deformable cover. Thus, when the connection portion of the bottom plate and the slat presses the cover of the cutout recess as the bottom plate of the shutter curtain kept in a fully closed state is lifted, it is possible to cause the connection portion to rotate more toward the interior side to be more reliably engaged by the cutout recess. Preferably, in a normal situation, a rotatable cover is kept in a posture due to a spring member, in which the cover closes the cutout recess.

Further, as a detection section for detecting deformation of the cover is provided in the vicinity of the above-described cutout recess, it is possible to generate an alarm sound and transmission of a detection signal to a crime prevention management system or the like immediately at the time of detection made by the detection section, in order to cause the malicious outsider to give up any intended intrusion to the inside of the structure. Moreover, in a shutter device which is constructed such that breaking control is applied to a winding drum or a rotation restriction is applied to an opening and closing machine while the shutter curtain is kept in a fully closed state to thereby restrict descending of the shutter curtain by utilizing its own weight, when it is controlled such that the restriction of the self weight descending of the shutter curtain is released upon receipt of the detection signal, the weight of the shutter curtain in self-weight descending is borne on the lowest portion of the curtain. This makes it difficult to attain manual lifting or lifting using a jack-up device of the shutter, and therefore a crime prevention function can be improved.

With a structure having hardware having an engaging prong, when a shutter curtain is lifted from the lower surface of the bottom plate using a tool such as a crowbar while the shutter is kept in a closed state, the curtain pieces which are bent in association with the lifting press such that the interior or exterior side lateral wall of the guide laid is expanded, and the curtain piece is caused to be engaged by the engaging prong, making it possible to prevent lifting of the shutter curtain. In the above, when the shutter curtain comprises slats, an interlock portion is engaged by the engaging prong, making it possible to prevent lifting.

### BRIEF DESCRIPTION OF THE DRAWINGS

FIG. 1 is an entire front side view showing a shutter curtain constructed using slats, which is kept in a closed state;

FIG. 2 is a vertical cross sectional view with a part omitted showing a shutter curtain;

FIG. 3 is a vertical cross sectional view with a major portion shown enlarged, showing a lower end of the shutter curtain held in a fully closed state;

FIG. 4A is a horizontal cross sectional view of a major portion, showing the shutter curtain kept in a normal fully closed state;

FIG. 4B is a horizontal cross sectional view of a major element, showing a cover elastically deformed by an interlock portion which is protruded due to lifting of the bottom plate;

FIG. 5 is a vertical cross sectional view with a part omitted, showing the shut state when the shutter curtain comprising slats is subjected to lifting of the bottom plate;

FIG. 6 is a vertical cross sectional view with a part omitted, showing a state in which the interlock portion of the slat directly above the bottom plate is engaged by the cutout recess;

FIG. 7A is a horizontal cross sectional of a major element, showing another structure of a shutter curtain in a normal fully closed state;

FIG. 7B is a horizontal cross sectional of a major element showing a cover which is plastically deformed by the interlock portion due to lifting of the bottom plate;

FIG. 8 is a diagram showing still another embodiment, in which the left drawing shows the lower end of the shutter curtain kept in a fully closed state, while the right drawing shows a state in which the bottom plate is lifted from the state shown in the left drawing;

FIG. 9 is a diagram showing yet another embodiment, in which the left drawing shows the lower end of the shutter curtain kept in a fully closed state, while the right drawing shows a state in which the bottom plate is lifted from the state shown in the left drawing;

FIG. 10 is cross sectional views along the respective lines in FIG. 9;

FIG. 11 is a drawing showing a structure of an inner guide rail in the embodiment shown in FIG. 9;

FIG. 12 is a diagram showing a structure of a cover in the embodiment shown in FIG. 9;

FIG. 13 is a diagram showing still another embodiment, in which the upper drawing shows a state in which the cover rotates, while the lower drawing shows a state in which the cover remains in a normal posture;

FIG. 14 is a diagram showing details of the cover shown in FIG. 13;

FIG. 15A and FIG. 15B are diagrams showing still another embodiment, with FIG. 15A being a horizontal cross sectional view of a major element showing a shutter curtain kept in a normal fully closed state, and FIG. 15B being a horizontal cross sectional view of a major element showing the cover rotated by the interlock portion which is protruded due to lifting of the bottom plate;

FIG. 16 is a drawing showing still another embodiment, in which the left drawing shows the lower end of the shutter curtain held in a fully closed state, and the right drawing shows a state in which the bottom plate is lifted from the state shown in the left drawing;

FIG. 17 is cross sectional views along the respective lines in FIG. 16, with the A-A cross sectional view being the same as that in FIG. 10;

FIG. 18 is a drawing showing a still another embodiment, in which the left drawing shows the lower end of the shutter curtain held in a fully closed state, and the right drawing shows a state in which the bottom plate is lifted from the state shown in the left drawing;

FIG. 19 is a drawing showing a structure of an intra-rail hook member in the embodiment shown in FIG. 16;

FIG. 20A is a side elevational view and a plane view of an essential element showing a shutter comprising a slat curtain kept in a closed state;

FIG. 20B is a side elevational view and a plane view of an essential element showing a state in which the bottom plate of the slat curtain is lifted;

FIG. 20C is a side elevational view showing hardware having an engaging prong formed thereon;

FIGS. 21A to 21B are drawings showing another embodiment, in which FIG. 21A being a side elevational view and a plane view of an essential element showing a shutter comprising a slat curtain kept in a shut state, FIG. 21B being a side elevational view and a plan view of an essential element showing a state in which the bottom plate of the slat curtain is lifted, and FIG. 21C being a side elevational view showing hardware having an engaging prong formed thereon;

FIG. 22A is a plane view with a major element of FIG. 20A shown enlarged;

FIG. 22B is a plane view with a major element of FIG. 20B shown enlarged;

FIG. 23A is a plane view with a major element of FIG. 21A shown enlarged;

FIG. 23B is a plane view with a major element of FIG. 21B shown enlarged;

FIG. 24A is a side elevational view and a plane view showing hardware having an engaging prong formed on a lateral piece;

FIG. 24B is an upper side view of the same;

FIG. 24C is a front side view and a plane view showing a state in which engaging prongs are formed on both lateral pieces;

FIG. 24D is an upper side view of the same;

FIG. 25A is a plane view showing hardware having an engaging prong formed on a lateral piece;

FIG. 25B is a plane view showing a state in which the bottom plate of the shutter curtain is lifted;

FIG. 26A is a side view showing a state in which hollow type slats are connected in the vertical direction via an interlock;

FIG. 26B is a side elevational view showing a shutter curtain comprising hollow type slats kept in a shut state;

FIG. 26C is a side elevational view showing a state in which the bottom plate of a hollow type slat curtain is lifted and an engaging hole of the hollow type slat is engaged by an engaging prong;

FIG. 27A is a side elevational view showing a pipe curtain comprising pipes connected in the vertical direction via a link plate, kept in a shut state;

FIG. 27B is a side elevational view showing a pipe curtain kept in a shut state;

FIG. 27C is a side elevational view showing a state in which the bottom plate of the pipe curtain is lifted and a pipe is engaged by an engaging prong of hardware;

FIG. 28A is a prospective view of a major element showing a state in which an engaging hook is mounted;

FIG. 28B is a prospective view of a major element showing an engaging hook on the same posture;

FIG. 29A is a plane view showing a positional relationship between a guide rail and a slat in a normal situation;

FIG. 29B is a plane view showing a state of an engaging hook and an engaging projecting portion with an external force applied thereto from the exterior side;

FIG. 30A is a plane view showing a positional relationship between a guide rail and a slat in a normal situation;

FIG. 30B is a plane view showing a state of the engaging hook and engaging projecting portion with an external force applied thereto from the exterior side;

FIG. 31A is a plane view showing another embodiment showing a positional relationship between a guide rail and a slat in a normal situation;

FIG. 31B is a plane view showing another embodiment showing a state of the engaging hook and engaging projecting portion with an external force applied thereto from an external side;

FIG. 32A is a plane view showing another embodiment showing a positional relationship between the guide rail and the slat in a normal situation;

FIG. 32B is a plan view showing another embodiment showing a state in which an engaging hook and an engaging projecting portion with an external force applied thereto from the exterior side;

FIG. 33 is a front side view showing a slat;

FIG. 34 is a diagram showing a switch box according to the present invention with a lid body thereof left open for convenience of explanation, in which the left drawing shows a state of a plate spring member in a normal situation with the plate spring member projecting toward the side of the lid body and resulting in a bow shape, and the right drawing shows a state of a plate spring member when the stop button is pressed, with the plate spring member projecting toward the press button switch side and resulting in a bow shape;

FIG. 35 is a drawing showing a switch box according to the present invention, in which the left drawing is a vertical cross sectional view, and the right drawing is a front side view with a part omitted;

FIG. 36 is a diagram showing a structure for mounting a plate spring member and a lid body;

FIG. 37 is a diagram explaining a mechanism for preventing pressing of the stop button from being released; and

FIG. 38 is a diagram explaining a mechanism for preventing pressing of the stop button from being released.

### BEST MODE FOR CARRYING OUT THE INVENTION

In the first to seventh embodiments, a cutout recess is integrally formed on the guide groove of a guide rail, and by bringing the interlock portion, which is bent as the bottom plate is being lifted, into engagement with the cutout recess, lifting of the shutter curtain kept in a fully closed state can be prevented. These embodiments are applied mainly to heavy weight shutters, but the application of these embodiments is not thus limited.

### First Embodiment

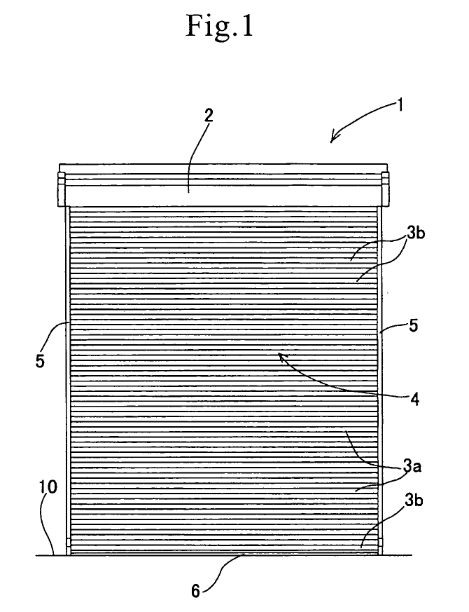

An embodiment of the present invention will be described in detail with reference to the attached drawings. In FIG. 1, 1 refers to a shutter device installed in an opening section of a construction. The shutter device 1 is constructed such that a shutter curtain 4 which comprises a plurality of slates 3a, 3a, . . . and 3b, 3b, . . . pivotally connected in the vertical direction, is wound around a winding drum, not shown, within the shutter case 2 provided on the upper portion of the opening section; the opening section of the construction is opened or closed while keeping both ends of the shutter curtain 4 inserted in the guide grooves 8 formed on the front faces 7, 7, opposed to each other and having a space in between, of the guide rails 5, 5 which stand on the right and left sides of the opening section of the construction; and, when the bottom plate 6 provided at the lowest portion of the shutter curtain 4 in a fully closed position reaches the floor, the lower limit switch, not shown, is switched off, suspending feeding rotation of the winding drum. Moreover, a braking mechanism, not shown, restricts free rotation of the winding dram, so that the shutter fully closes the opening section of the construction, while being suspended in a state in which self-weight descending is restricted.

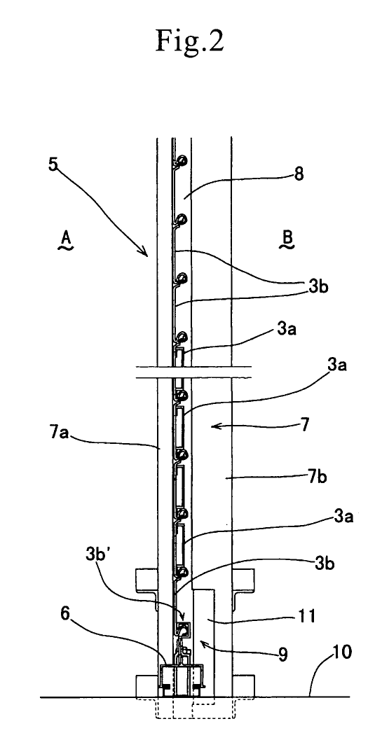

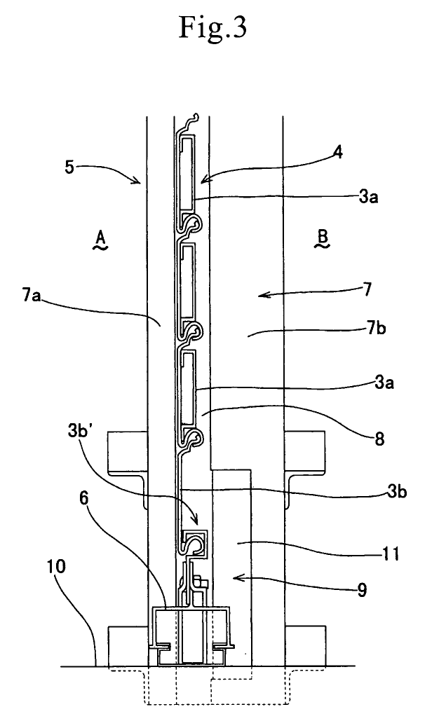

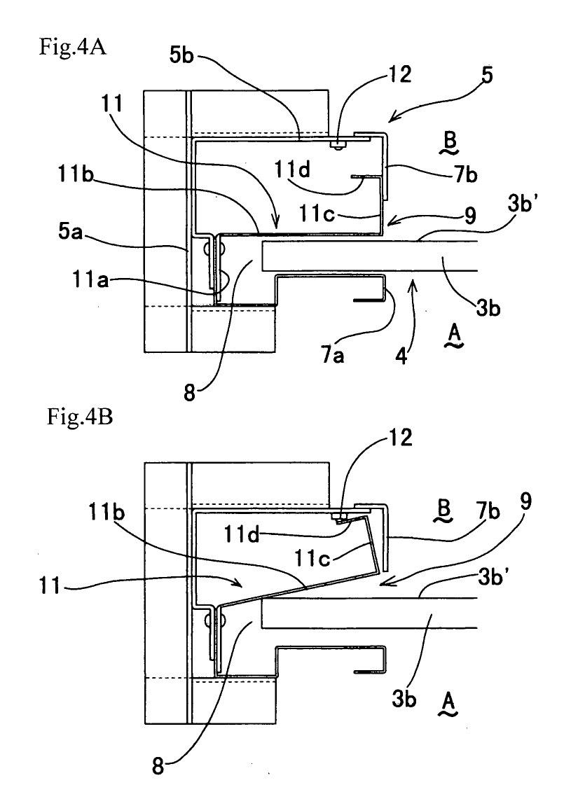

Here, as shown in FIGS. 2 and 3, of an exterior side A plane portion 7a and an interior side B plane portion 7b of the front faces 7, 7 which define the guide groove 8, a cutout recessed part 9 is formed on the interior side B plane portion 7b as being horizontally cutout so as to have an inverted C shape viewed in the drawing. The cutout recessed part 9 is formed in an area between the floor surface 10 and a level a predetermined height above that, integrally and so as to communicate with the guide groove 8. As shown in FIG. 4A, a cover 11 is arranged at the cutout recessed part 9, extending from the inside of the guide rail 5 and closing off the recess.

That is, the cover 11 is made using an elastically deformable metal plate. When viewed in the drawing, it is constructed such that the distal end surplus portion 11c of the body 11b with the proximal end 11a thereof fixed on the rear piece 5a side of the guide rail 5 is bent in the direction of the interior side plane portion 7b along the region where the guide groove 8 is formed, and the end surface 11d of the distal end surplus portion 11c is bent toward the inside of the guide rail 5. Further, on the inner surface of the interior side piece 5b of the guide rail 5, a detection switch 12 for serving as a detection section is provided. As shown in FIG. 4B, when the cover 11 is pressed by the interlock portion 3b′ of the slat 3b which is located directly above the bottom plate 6, the cover 11 then deforms toward the interior side B, and thereby causes the end surface 11d of the distal end surplus portion 11c to abut on the detection switch 12, thus detecting the fact that an attempt to lift the bottom plate 6 of the shutter curtain 4 kept in a fully closed state has been made.

It should be noted that, as for the above-described shutter curtain 4, hollow type slats 3a,3a . . . , each of which has a dual structure having a hollow portion are used for the portion from the floor surface 10 level up to the level approximately as high as the height of a person, and normal slats 3b, 3b . . . each of which is made using a single metal plate are used for the portion thereabove up to the shutter case 2 and the slats winding around a winding drum, not shown. The use of the above-described hollow type slats 3a, 3a . . . gives the shutter curtain 4 a higher crime prevention function against a malicious outsider who may attempt to intrude inside the construction by tearing the slats using a crowbar or metal saw. Also, the reason why a normal slat 3b which is made using a single metal plate is used for the slat located directly above the bottom plate 6 is in consideration of when a bent interlock portion is brought to be engaged by the above-described cutout recessed part 9.

With the above described structure, in a normal operation to close the opening section of a building, a shutter curtain 4 which winds around a winding drum is fed out from the shutter case 2 when a close button, not shown, is operated, and begins descending with the both edges thereof being guided by the guide grooves 8, 8 each formed on the right and left sides. Then, when the bottom plate 6 at the lowest edge of the above-described shutter curtain 4 reaches the floor, a lower limit switch, not shown, stops the feeding rotation operation of the winding drum with free rotation of the winding drum being braked. Accordingly, the shutter curtain 4 hanging in the opening section of the construction is left in a condition in which the descending by utilizing its own weight is restricted. That is, the opening section of the construction is fully closed by the shutter curtain 4 which is then suspended in a condition such that the weight of the shutter curtain 4 is not borne on the bottom plate 6.

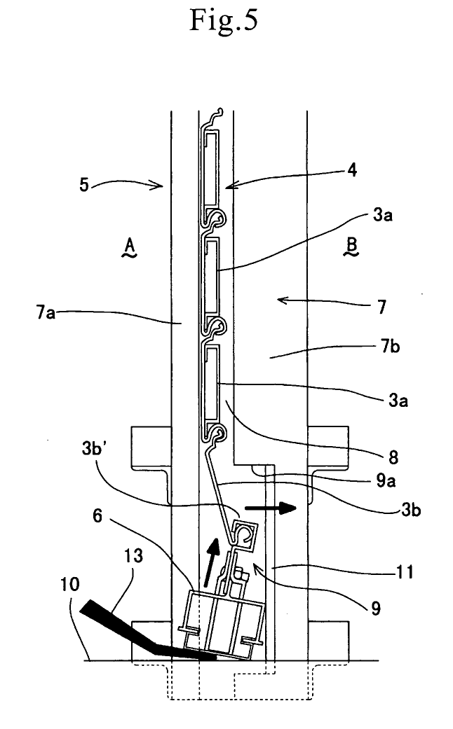

When a malicious outsider attempts to intrude inside the construction from the exterior side A using a tool such as a crowbar 13 while the opening section of the building remains fully closed by the shutter curtain 4 as described above, and specifically inserts the tip end of the crowbar 13 into the narrow space formed between the lower surface of the bottom plate 6 and the floor surface 10, as shown in FIG. 5, the bottom plate 6 is caused to incline as indicated by the arrow shown directing diagonally upward. This change in inclination triggers upward movement of the slat 3b connected directly above the bottom plate 6, which is resultantly pivot via an interlock portion 3b′, which is opposed to the cutout recessed part 9. Further, as the end portion of the bottom plate 6 located closer to the interior side B abuts on the cover 11, the cover 11 is pressed towards the interior side B in the horizontal arrow direction and thereby elastically deformed. Then, when the end surface 11d formed on the distal end surplus portion 11c of the above-described cover 11 abuts on a detection switch 12 formed on the inner surface of the interior side piece 5b of the guide rail 5, the switch 12 detects the fact that an attempt to lift the bottom plate 6 has been made for the shutter curtain 4 kept in a fully closed state. When a detection signal is sent to a control section, not shown, self-weight descending restriction applied to the shutter curtain 1 is released, and the weight of the shutter curtain 1 now descending by utilizing its own weight becomes borne on the lowest portion of the shutter curtain 1. This makes it difficult to attempt manual lifting of the shutter curtain 1.

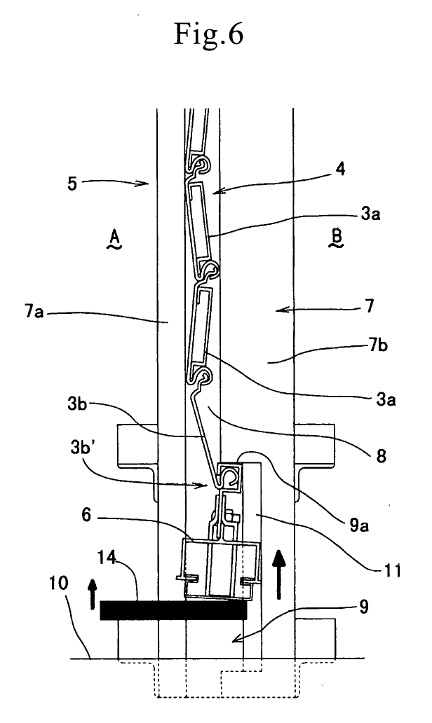

Further, when the malicious outsider inserts the lifting arm 14 of a jack-up device, not shown, into the space below the lower surface of the bottom plate 6 with the bottom plate 6 kept lifted using a crowbar 13, and proceeds with a jack-up operation, although the bottom plate 6 may be temporarily moved slightly upward, as shown in FIG. 6, when the interlock portion 3b′ of the slat 3b is brought to abut on and engaged by the upper edge 9a of the recess 9, further lifting of the shutter curtain 4 becomes substantially impossible. This leaves the malicious outsider with no other choice but to give up intrusion into the inside of the building. Thus, the crime prevention effect for the shutter curtain 1 can be highly improved. It should be noted that, although the cover 11 for closing the recess 9, which is made using an elastically deformable metal plate is described in the first embodiment, this is not an exclusive example. The cover 11 may be made using a spring steel piece so as to enable elastic deformation, and alternatively, may be formed using an elastic rubber which is desirably molded so as to fit the cutout recessed part 9 so that the elasticity thereof is utilized.

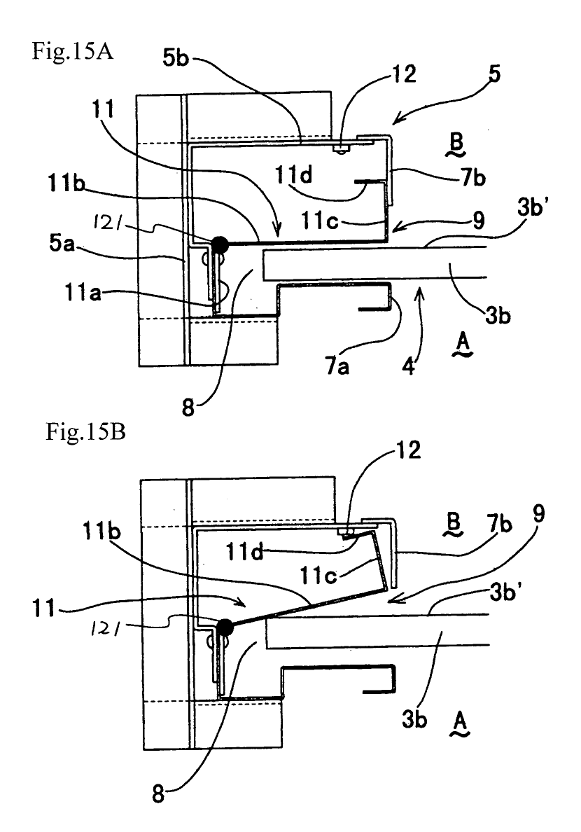

FIG. 15 shows another embodiment of the cover 11, in which the proximal end of the body 11b is pivotally connected to the base end portion 11a via a spring hinge 121. In a normal situation, as shown in FIG. 15A, due to the spring hinge 121, the distal end surplus portion 11c remains closing the cutout recessed part 9. When the bottom plate 6 is lifted upward and consequently inclines while the opening section is kept fully closed, the interlock portion 3b′ of the slat 3b, which is located on the upper end side of the bottom plate 6, is brought to abut on, and thereby rotate, the body 11b. As a result, the interlock portion 3b′ of the slat 3b abuts on, and is engaged by, the upper edge 9a of the cutout recessed part 9, as shown in FIG. 15B, thus restricting upward movement of the shutter curtain 4.

### Second Embodiment

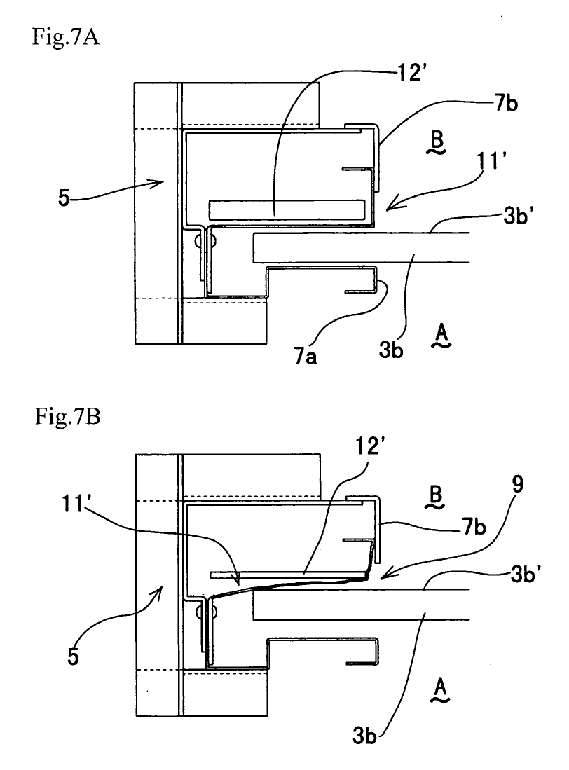

The above-described first embodiment is constructed such that the cover 11 is made using an elastically deformable metal plate, and the end surface 11d of the distal end surplus portion 11c of the cover 11 is caused to abut on the detection switch 12 formed on the inner surface of the interior side piece 5b of the guide rail 5, thus detecting that an attempt has been made to lift the bottom plate 6. Alternatively, as shown in FIG. 7A, another structure may be constructed in which a plastically deformable metal plate is bent into the same shape as that which is described in the first embodiment to make a cover 11′, and a detection portion 12′ is provided inside thereof so that, as shown in FIG. 7B, when the cover 11′ is pressed by the interlock portion 3b′ of the slat 3b located directly above the bottom plate 6, the cover 11′ then deforms onto the interior side B and thereby deforms the detection portion 12′, thus detecting the fact that an attempt has been made to lift the bottom plate 6 for the shutter curtain kept in a fully closed state.

In the first and second embodiments, there is disclosed a lifting prevention structure for a shutter curtain, in which, in a shutter device in which both of the right and left edges of a shutter curtain which comprises a plurality of slats connected in the vertical direction via an interlock portion are guided for ascending and descending by guide grooves formed on the guide rails each standing on each side of the opening section of the construction, to thereby open and close the opening section of a construction, a cutout recessed part 9 is integrally formed in the guide groove 8 of each guide rail 5 by cutting out in the horizontal direction the interior side plane portion 7b of the front face 7 located above and in the vicinity of the floor surface 10, so that, when the bottom plate 6 of the shutter curtain 4 kept in a fully closed state is lifted, the interlock portion 3′ (a connection portion of the bottom plate 6 and the slat 3b) of the slat 3b located directly above the bottom plate 6, which is opposed to the cutout recessed part 9, is engaged by the cutout recessed part 9, thus preventing lifting of the shutter curtain 4. Although, a type in which the upper end of the bottom plate 6 which constitutes the interlock portion 3b′ (the connection portion) is engaged by the upper edge 9a of the cutout recess is shown in the interlock portion 3B (a connection portion), a type in which the lower end of the slat 3b which constitutes the interlock portion 3b′ (a connection portion) is engaged by the upper edge 9a of the cutout recessed part 9 of the bottom plate 6 is also applicable.

### Third Embodiment

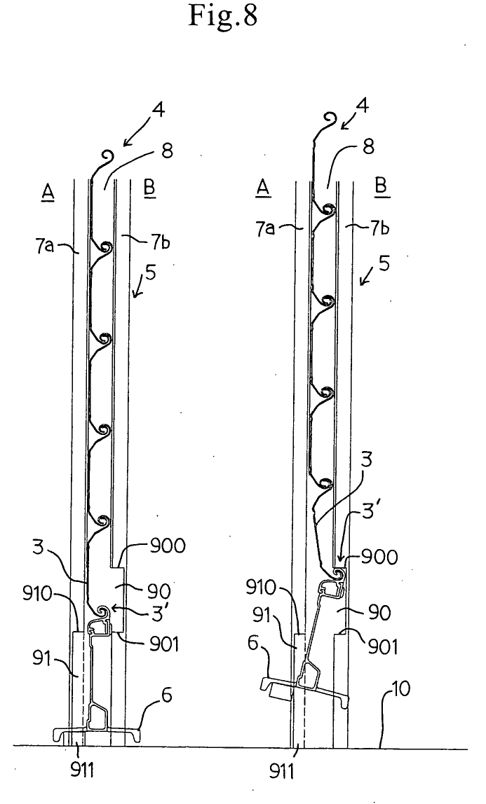

The third embodiment will be described based on FIG. 8. The left and right drawings of FIG. 8 correspond to FIGS. 3 and 6, respectively, in which identical structural elements are given identical reference numbers and the above description regarding the structural elements with identical reference numbers can be incorporated here as well. The left drawing of FIG. 8 shows the lower end of the shutter curtain which keeps the opening section in a fully closed state. A guide groove 8 of the guide rail 5 is formed in a space between the exterior side plane portion 7a and the interior side plane portion 7b, both of which constitute the front face of the guide rail 5.

On the interior side plane portion 7b, an interior side cutout recessed part 90 is formed in an area and upward therefrom, which is located on the upper end side of the bottom plate 6 of the shutter curtain 4 which keeps the opening section in a fully closed state. The horizontal upper edge 900 of the interior side cutout recessed part 90 constitutes an engagement portion. In a fully closed state, the lower edge 901 of the interior side cutout recessed part 90 is located opposed to the connection portion (an interlock portion) 3′ of the bottom plate 6 and the slat 3. The upper edge 900 of the interior side cutout recessed part 90 is formed in an area above by a predetermined distance from the position opposed to the connection portion 3′ of the bottom plate 6 and the slat 3. The connection portion of the bottom plate and slat of the shutter curtain kept in a fully closed state and the upper edge of the interior side cutout recess have positional relationship such that hardly any space is caused between the bottom plate and the floor surface when an attempt is made to lift the bottom plate 6 from the exterior side. The position of the lower edge 901 of the interior side cutout recessed part 90 is not limited to the position shown, and may be below the position opposed to the connection portion 3′. That is, the position of the lower edge 901 of the interior side cutout recessed part 90 is not limited as long as it allows inclination of the bottom plate 6 and formation of a space for allowing the connection portion 3′ of the bottom plate 6 and the slat to go into the recess 90 so that the connection portion 3′ can be engaged by the upper edge 900 of the recess 90 when the bottom plate 6 is lifted.

On the exterior side plane portion 7a, an exterior side cutout recessed part 91 is formed in an area opposed to the bottom plate 6 of the shutter curtain 4 kept in a fully closed state. The exterior side cutout recessed part 91 is formed lower than the interior side cutout recessed part 90. In FIG. 8, the upper edge 910 of the exterior side cutout recessed part 91 is opposed to the connection portion 3′ of the bottom plate 6 and the slat 3 (the same height as that of the lower edge 901 of the interior side cutout recessed part 90), and the lower edge 911 of the exterior side cutout recessed part 91 is at the floor surface level. The exterior side cutout recessed part 91 has a size substantially equal to the entire height of the bottom plate 6. However, the positions of the upper edge 910 and lower edge 911 of the exterior side cutout recessed part 91 are not limited as long as the position allows formation of a space into which the lower edge of the bottom plate 6 can go to thereby cause the bottom plate 6 to incline, when the bottom plate 6 in a fully closed state is lifted.

In the state shown in the left drawing of FIG. 8, when the bottom plate 6 of the shutter curtain 4 kept in a fully closed state is lifted by inserting a tool or the like from the outside into the space between the bottom plate 6 and the floor surface, the bottom plate 6 is caused to incline with the bottom plate 6 moving upward and the lower end side thereof moving toward the exterior side through the recess 91. Further, the connection portion 3b′ of the bottom plate 6 and the slat 3 moves toward the interior side and goes into the interior side cutout recessed part 90. Then, the connection portion of the bottom plate 6 and the slat 3 is engaged••by the upper edge 900 of the interior side cutout recessed part 90 while the bottom plate 6 is kept in an inclined posture, thus preventing lifting of the shutter curtain 4. Also, a deformable cover as described in the first and second embodiments may be attached to the interior side cutout recessed part 90 and the exterior side cutout recessed part 91. Alternatively, a deformable cover to be descried later or a rotatable cover may be attached to the interior side cutout recessed part 90 and the exterior side cutout recessed part 91.

### Fourth Embodiment

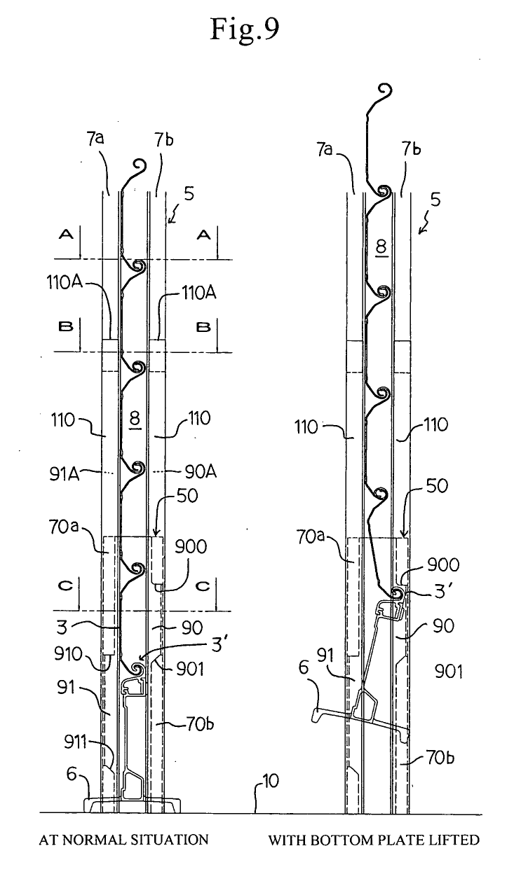

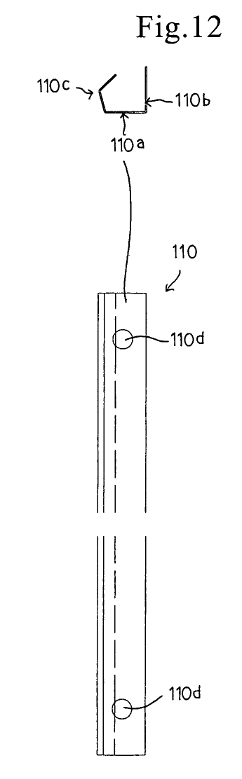

The fourth embodiment will be described based on FIGS. 9 to 12. In the fourth embodiment, the guide rail of the shutter device comprises an outer guide rail 5 and an inner guide rail 50 which is provided inside the outer guide rail 5. The inner guide rail 50 constitutes an intra-rail hook member. The outer guide rail substantially corresponds to a normal guide rail, assigned the same reference number 5 as that assigned to the guide rail described above for explanation. The outer guide rail 5 has a length corresponding to the height of the opening section. The inner guide rail 50 is shorter compared to the outer guide rail S and is provided in a lower part of the outer guide rail 5. The outer guide rail 5 has a substantially U shape in a cross sectional view formed by a rear piece 5a, an interior side lateral piece 5b, and an exterior side lateral piece 5c. Exterior side planes 7a, 7a′ and interior side plane portions 7b, 7b′, which define a guide groove 8, are integrally formed on the distal ends 5b′, 5c′ on the opening section side of the lateral pieces 5b, 5c.

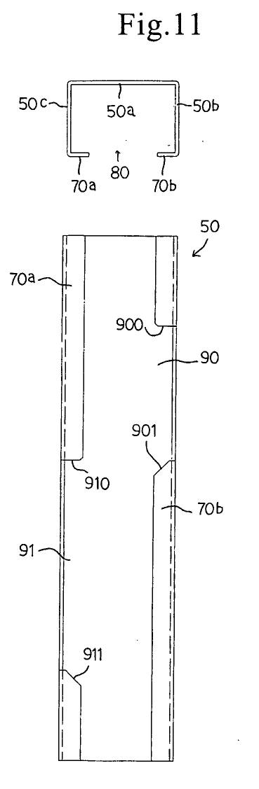

FIG. 11 is a diagram showing an inner guide rail 50. The inner guide rail 50 comprises a rear piece 50a, an interior side piece 50b, and an exterior side piece 50c, and has a substantially U shape in a cross sectional view. The inner guide rail 50 further comprises an exterior side front face 70a which is integrally formed on the exterior side piece 50c and an interior side front face 70b which is integrally formed on the interior side piece 50b. A guide groove 80 is formed between the exterior side front face 70a and the interior side front face 70b, and receives the end portion in the width direction of the shutter curtain 4. The inner guide rail 50 is provided on the outer guide rail S such that the rear piece 50a, interior side piece 50b, and exterior side piece 50c abut on the inner wall surfaces of the rear piece 5a, interior side piece 5b, and exterior side piece 5c of the outer guide rail 5, respectively, and that the guide groove 80 and guide groove 8 form a guide groove for receiving the end portion in the width direction of the shutter curtain. Within the guide groove 80 of the inner guide rail 50, an interior side cutout recessed part 90 is formed on an upper portion of the interior side plane portion 70b, while an exterior side cutout recessed part 91 is formed on a lower portion of the exterior side plane 70a. The upper edge 900 of the interior side cutout recessed part 90 is horizontal, while the lower edge 901 thereof is tilted. The upper edge 910 of the exterior side cutout recessed part 91 is horizontal, while the lower edge 911 thereof is tilted. The lower edge 901 of the interior side cutout recessed part 90 and the upper edge 910 of the exterior side cutout recessed part 91 are opposed to each other. The exterior side cutout recessed part 91 is located lower than the interior side cutout recessed part 90.

FIG. 9 corresponds to FIG. 8. The left drawing corresponds to a normal situation, while the right drawing corresponds to when the bottom plate is lifted. In a fully closed state, the tilted lower edge 901 of the interior side cutout recessed part 90 is opposed to the connection portion 3′ of the bottom plate 6 and the slat 3.•• The upper edge 900 of the interior side cutout recessed part 90 is formed in an area above by a predetermined distance from the position opposed to the connection portion 3′ of the bottom plate 6 and the slat 3. The position of the lower edge 901 of the interior side cutout recessed part 90 is not limited to the position shown, and the lower edge 901 may be located below the position opposed to the connection portion 3′. That is, the position of the lower edge 901 of the interior side cutout recessed part 90 is not limited as long as the position allows inclination of the bottom plate 6 and formation of a space for allowing the connection portion 3′ of the bottom plate 6 and the slat 3 to go into the interior side cutout recessed part 90 so that the connection portion 3′ can be engaged by the upper edge 900 of the interior side cutout recessed part 90 when the bottom plate 6 is lifted.

On the exterior side plane 70a, an exterior side cutout recessed part 91 is formed in a portion opposed to the bottom plate 6 of the shutter curtain 4 kept in a fully closed state. The exterior side cutout recessed part 91 is formed lower than the interior side cutout recessed part 90. In FIG. 9, the upper edge 910 of the exterior side cutout recessed part 91 is opposed to the connection portion 3′ of the bottom plate 6 and the slat 3 (the same height as that of the lower edge 901 of the interior side cutout recessed part 90), and the tilted lower edge 911 of the exterior side cutout recessed part 91 is located slightly above the lower end of the bottom plate 6. The positions of the upper and lower ends of the second cutout portion 91 are not limited as long as the positions allow formation of a space into which the lower edge of the bottom plate 6 can go into to thereby incline the bottom plate 6, when the bottom plate 6 kept in a fully closed state is lifted.

The exterior side plane portion 7a, 7a′ and interior side plane portion 7b, 7b′ of the outer guide rail 5 are cutout in the lower portion thereof which contains the entire height of the inner guide rail 50, together with the distal ends 5b′, 5c′ on the opening section side of the lateral pieces 5b, 5c, and an exterior side cutout recessed part 91A and an interior side cutout recessed part 90A are formed. The interior side cutout recessed part 90A is located opposed to a portion which contains the upper edge 900 of the interior side cutout recessed part 90 of the inner guide rail 50, while the exterior side cutout recessed part 91A is opposed to a portion which contains the bottom plate 6 of the shutter curtain 4 in a fully closed state.

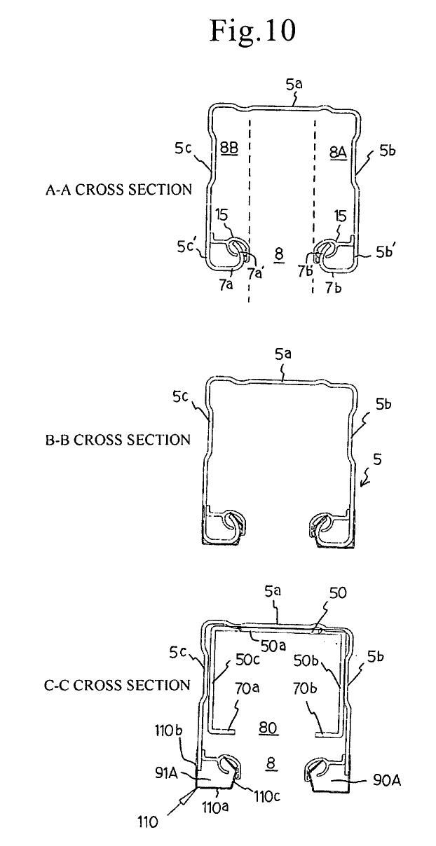

The outer guide rail 5 has deformable cover bodies 110 to close the exterior side cutout recessed part 91A and interior side cutout recessed part 90A, respectively. The interior side cutout recessed part 90A formed in the interior side plane portion 7b of the guide rail 5 and the interior side cutout recessed part 90 formed in the interior side plane portion 70b of the inner guide rail 50 are concealed by the interior side cover body 110. The exterior side cutout recessed part 91A formed on the exterior side plane portion 7a of the guide rail 5 and the exterior side cutout recessed part 91 formed on the exterior side plane 70a of the inner guide rail 50 are concealed by the outside cover bodies 110. In the embodiment, the cover 110 is an elastically deformable cover which is made using spring steel, and comprises a front piece 110a corresponding to the front face 7a, 7b of the outer guide rail 5, a lateral piece 110b corresponding to the lateral piece of the outer guide rail 5, and a bent piece 110c projecting toward the guide groove 8. As shown in the lower drawing of FIG. 10, in a normal situation, the front piece 110a and bent piece 110c of the cover 110 extend toward the guide groove side more than the interior side plane portion 70b and exterior side plane 70a of the inner guide rail 50. Screw holes 110d are formed on the upper and lower portions of the front piece 110a, and the cover 110 is attached to the front face 7a, 7b of the outer guide rail 5 using a screw, not shown. In FIG. 9, the upper end 110A of the cover 110 is located above the line B-B, and the lower end of the cover 110 extends to the vicinity of the floor surface 10. The cover 110 is attached to the guide rail 5 in the upper and lower ends thereof using a screw such that the substantially middle portion thereof in the height direction is located in the engaging portion where the connection portion 3′ of the bottom plate 6 and the slat 3 is engaged (in the cover 110, deformation of the cover 110 is constrained at points where the cover 110 is lock fitted to the guide rail 5 using a screw, with the lock fitting portion referred to as a constrained portion. It should be noted that, although a screw is used as lock fitting means in this embodiment, the lock fitting means may be any other means, such as caulking). With this arrangement, the engaging portion where the connection portion 3′ of the bottom plate 6 and the slat 3 is engaged can be located further apart from the constrained portion of the cover 110. This makes it possible to ensure a larger amount of deformation of a portion of the cover 110 on which the connection portion 3′ may abut and press. In an explanation based on the embodiment shown in FIG. 9, the cover 110 has sufficient height such that, when being mounted to the guide rail 5 at the upper and lower ends thereof, the substantially middle portion thereof in the height direction corresponds to the upper edge 900 of the interior side cutout recessed part 90 which constitutes an engaging portion by which the connection portion 3′ of the bottom plate 6 and the slat 3 is engaged, and moreover, a sufficient distance can be ensured between the upper/lower end thereof and the upper edge 900. Then, the cover 110 is mounted to the exterior side plane portion 7a and interior side plane portion 7b of the guide rail 5 using a screw, not shown, in the upper and lower ends thereof such that the substantial middle portion thereof in the height direction is located in the upper edge 900 of the interior side cutout recessed part 90 where the connection portion 3′ of the bottom plate 6 and the slat 3 is engaged. This ensures a larger portion between the upper edge 900 of the interior side cutout recessed part 90 which constitutes the engaging portion, and the constrained portion (the upper and lower ends) of the cover 110.

The cover 110 serves to function as a guide for preventing, in normal ascending operation of the shutter curtain 4, the bottom plate 6 of the shutter curtain 4 from inclining via the interior side cutout recessed part 90 and exterior side cutout recessed part 91 while pressing, and thereby deforming, the cover 110, so that the connection portion 3′ of the bottom plate 6 and the slat 3 is not engaged by the upper edge 900. The cover 110 is not deformed by a force such as is applied thereto when the bottom plate 6 and the slat 3 (containing an interlock portion constituting a connection portion) touch the cover 110 in normal ascending and descending operation of the shutter curtain 4. The cover 110 is strong enough to be deformed in response to a stronger force applied thereto when the bottom plate is forcibly lifted from the exterior side using a tool while the opening section is kept in a fully closed state. As is obvious from the C-C cross sectional view in FIG. 10, the front piece 110a and bent piece 110c of the cover 110 are mounted to the guide rail 5, closing the exterior side cutout recessed part 91A, and the interior side cutout recessed part 90A, and the front faces 70a, 70b of the inner guide rail 50. It should be noted that a longitudinal resin silencer 15 may be attached to the insertion opening of the guide groove 8 of the guide rail 5.

In normal ascending and descending operation of the shutter curtain 4, the lower end portion of the shutter curtain 4 (the slat 3 and bottom plate 6) is guided by the cover 110, and therefore the bottom plate 6 does not incline and go into the interior side cutout recessed part 90 and/or exterior side cutout recessed part 91 and the connection portion 3′ of the bottom plate 6 and the slat 3 is not engaged with the upper edge 900 of the interior side cutout recessed part 90. When the bottom plate 6 is lifted from the exterior side using a tool or the like while the opening section is kept fully closed, the bottom plate 6 causes the connection portion of the bottom plate 6 and the slat 3 to deform the cover 110 so that is spreads out toward the interior side, and simultaneously the lower end side of the bottom plate 6 deforms the cover 110 so as to spread out toward the exterior side, and the lower end side of the bottom plate 6 moves toward the exterior side through the exterior side cutout recessed part 91 of the inner guide rail 50. As a result, the connection portion 3′ of the bottom plate 6 and the slat 3 goes into the interior side cutout recessed part 90 formed in the interior side plane portion 70b and is engaged by the upper edge 900 of the recess 90.

In the fourth embodiment, as an embodiment in which the engagement portion, by which the connection portion 3′ of the bottom plate 6 and the slat 3 is engaged when the bottom plate is lifted from the exterior side while the opening section is kept in a fully closed state, is located in the inner space of the guide rail 5, an intra-rail hook member comprising an inner guide rail 50 having a substantially U shape cross sectional view is described. The structure of the intra-rail hook member is not limited to the one using an inner guide rail, and an applicable intra-rail hook member is such that an engagement portion is located at a position higher than the connection portion of the bottom plate 6 and the slat 3 of the shutter curtain in a fully closed state, within the interior side space 8a in the intra-guide rail space, with the interior side space 8 comprising a guide groove 8 for receiving the end portion of a shutter curtain, the interior side space 8A of the guide groove 8, and the exterior side space 8B of the guide groove 8, and such that an engagement portion, by which the connection portion can be engaged when the bottom plate is lifted from the exterior side and thereby inclined and the connection portion of the bottom plate and slat moves toward the interior side, can be provided. Other intra-rail hook members having other engagement portions may also be applicable. Intra-rail hook members having other structures will be described later.

### Fifth Embodiment

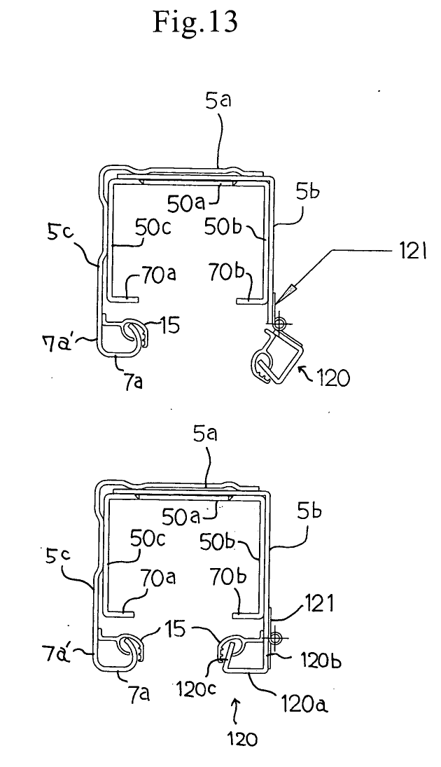

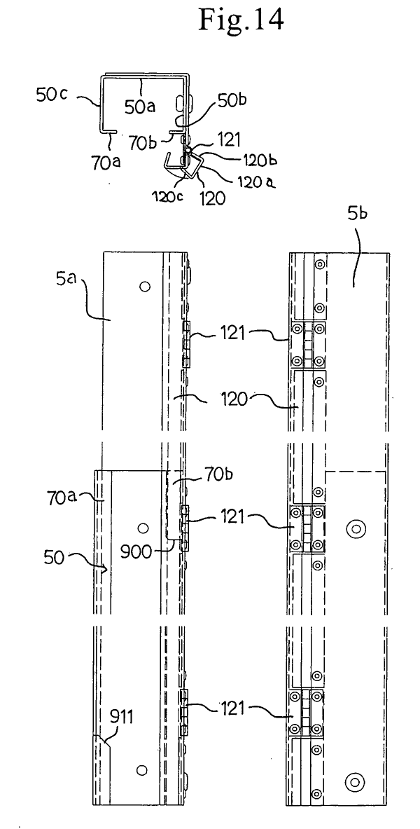

FIGS. 13 and 14 show the fifth embodiment 5, in which the deformable cover 110, which is mounted to the interior side plane portion 7b in the fourth embodiment, is substituted by a rotatable cover 120. Regarding the structures other than the cover, descriptions in the fourth embodiment can be incorporated here as well. The cover 120 comprises a front piece 120a, a lateral piece 120b, and a bent piece 120c which projects into the guide groove. The cover 120 is such that the base end side of the lateral piece 120b is mounted to the interior side piece 5b of the outer guide rail 5 so as to allow rotation via a spring hinge 121. As shown in the lower drawing of FIG. 13, in a normal situation, the front piece 120a and bent piece 120c of the cover 120 extend towards the guide groove side more than the interior side plane portion 70b of the inner guide rail 50.

The outer guide rail 5 has an interior side plane portion 7b, 7b′ and an exterior side plane portion 7a, 7a′, which are opposed to the interior side plane portion 70b and exterior side plane portion 70a of the inner guide rail 50, respectively. An interior side cutout recessed part 90A is formed containing a portion opposed to the interior side cutout recessed part 90 formed on the interior side plane portion 70b of the inner guide rail 50. A rotatable cover 120 is attached so as to close the interior side cutout recessed part 90A.

In a normal ascending and descending operation of the shutter curtain, the cover 120 is held in a posture, due to the spring force of the spring hinge 121, which restricts the bottom plate 6 from inclining and the connection portion 3′ of the bottom plate 6 and the slat 3 from going into the interior side cutout recessed part 90 (the lower drawing of FIG. 13). When a force is applied from the exterior side to the interior side, the cover 120 turns towards the interior side so as to expand against the spring force of the spring hinge 121 (the upper drawing of FIG. 13).

FIG. 14 is a diagram showing further details of the structure of the cover 120. The outer guide rail 5 comprises a piece constituting a rear piece 5a and a piece constituting an interior side piece 5b. The cover 120 is rotatably mounted to the distal end of the piece which constitutes the interior side piece 5b via the spring hinge 121. The height of the cover 120 may contain at least a portion corresponding to the interior side cutout recessed part 90 formed on the interior side plane portion 70b of the inner guide rail 50. It should be noted that, although FIGS. 13 and 14 show the cover 120 mounted to the interior side plane portion 7b, in the case where an exterior side cutout recess is formed also on the exterior side plane portion 7a, 7a′, a cover 120 may be provided to the guide rail so as to correspond to the exterior side cutout recess. Alternatively, a rotatable cover may be attached in place of the above-described deformable cover.

### Sixth Embodiment

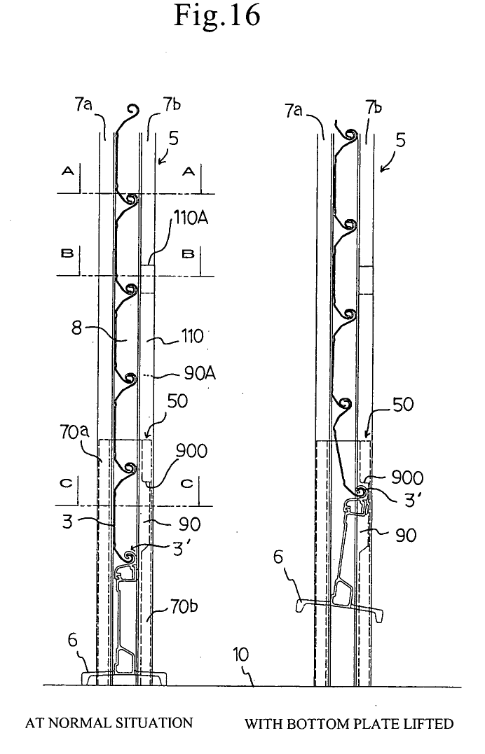

FIG. 16 shows a sixth embodiment 6, which is similar to the fourth embodiment shown in FIGS. 9 to 12. The sixth and fourth embodiments are different in that the sixth embodiment does not have either a cutout recess located on the exterior side or a cover for closing the cutout recess located on the exterior side. In FIG. 16, common members in the sixth and fourth embodiments are given identical reference numerals, and the description given in the fourth embodiment, except for parts regarding these members, can be basically incorporated as a description for the sixth embodiment. In the sixth embodiment, the guide rail of the shutter device comprises an outer guide rail 5 and an inner guide rail 50 which is formed inside the outer guide rail 5. The inner guide rail 50 constitutes an intra-rail hook member.

The outer guide rail substantially corresponds to a normal guide rail. The outer guide rail 5 has a length corresponding to the height of the opening section. The inner guide rail 50 is shorter compared to the outer guide rail 5 and is provided in a lower portion of the outer guide rail 5. The outer guide rail 5 has a substantially U shape in a cross sectional view formed by a bottom piece, an interior side piece, and an exterior side piece. On the distal ends on the opening section side of the lateral pieces, an exterior side plane portion 7a and an interior side plane portion 7b which define a guide groove are integrally formed. The inner guide rail 50 comprises a bottom piece, an interior side piece, and an exterior side piece, having a substantially U shape in a cross sectional view. The inner guide rail further comprises an exterior side front face 70a integrally formed on the exterior side piece and an interior side front face 70b integrally formed on the interior side piece. A portion between the exterior side front face 70a and interior side front face 70b constitutes a guide groove for receiving an end portion in the width direction of the shutter curtain 4. In the guide groove of the inner guide rail, a cutout recessed part 90 is formed in the upper portion of the interior side plane portion 70b. The upper edge 900 of the cutout recessed part 90 is horizontal, while the lower edge 901 thereof is tilted. FIG. 16 is a drawing corresponding to FIG. 9. The left drawing corresponds to a normal situation, while the right drawing corresponds to when the bottom plate is lifted. In a fully closed state, the tilted lower edge 901 of the cutout recessed part 90 is opposed to the connection portion 3′ of the bottom plate 6 and the slat 3, and the upper edge 900 of the cutout recessed part 90 is formed in a position above by a predetermined distance from the position opposed to the connection portion 3′ of the bottom plate 6 and the slat 3.

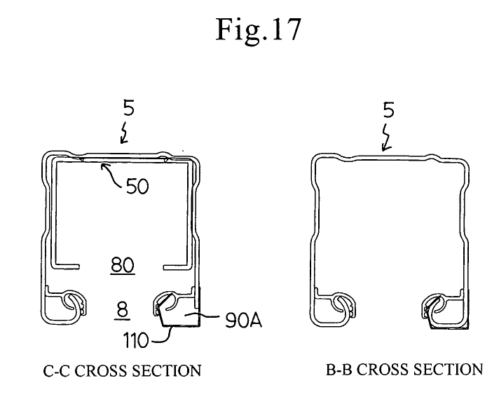

The interior side plane portion 7b, 7b′ of the outer guide rail 5 is cutout in the lower portion thereof which contains the entire height of the inner guide rail 50 together with the distal end 5b′ on the opening section side of the interior side piece 5b, and an interior side cutout recessed part 90A is formed. A deformable cover 110 is provided so as to close the interior side cutout recessed part 90A and the cutout recessed part 90 formed on the interior side plane portion 70b of the inner guide rail. The cover 110 serves to function as a guide for preventing the bottom plate 6 from inclining and the connection portion 3′ of the bottom plate 6 and the slat 3 from being engaged by the upper edge 900. The cover 110 also serves to conceal the inner guide rail 50. In normal ascending and descending of the shutter curtain 4, the shutter curtain 4 is guided by the cover 110, and the bottom plate 6 does not go into the cutout recessed part 90 and incline and the connection portion 3′ of the bottom plate 6 and the slat 3 is not engaged with the upper edge 900 of the interior side cutout recessed part 90. When the bottom plate 6 is lifted while the opening section is kept fully closed, the bottom plate 6 inclines, causing the cover 110 to expand toward the interior side, and simultaneously, the connection portion 3′ of the bottom plate 6 and the slat 3 goes into the interior side cutout recessed part 90 formed in the interior side plane portion 70b and is engaged by the upper edge 900 of the recess 90. FIG. 17 is a C-C cross sectional view and a B-B cross sectional view of FIG. 16. An A-A cross sectional view is the same as the A-A cross sectional view shown in FIG. 10.

### Seventh Embodiment

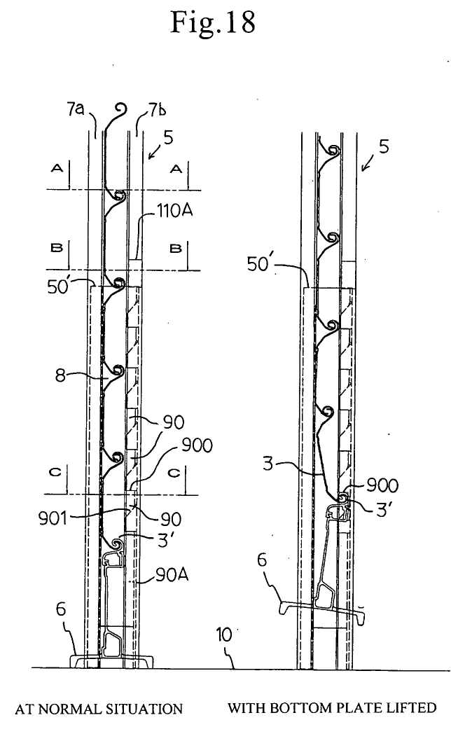

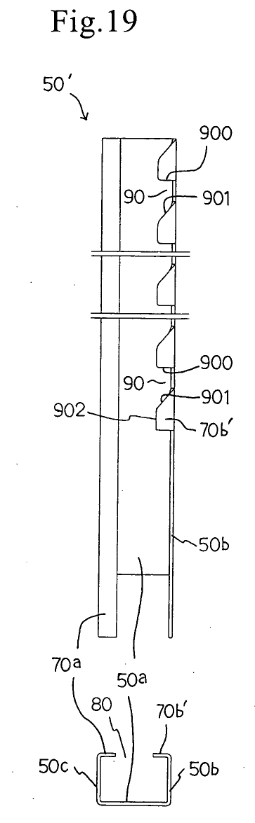

FIGS. 18 and 19 show another embodiment of an intra-rail hook member. As shown in FIG. 19, a hook member 50′ has a shape similar to that of the inner guide rail 50 shown in FIG. 11, in which identical structural elements are given identical reference numerals. The hook member 50′ is shorter compared to the outer guide rail 5, and provided in the lower portion of the outer guide rail 5. The outer guide rail 5 has a substantially U shape in a cross sectional view formed by a bottom piece, an indoor side piece, and an outdoor side piece. On the distal end on the opening section side of the lateral piece, an outdoor side plane 7a and an indoor side plane 7b, which define a guide rail groove, are integrally formed. The hook member 50′ comprises a rear piece 50a, an interior side piece 50b, and an exterior side piece 50c, having a substantially U shape in a cross sectional view. The hook member 50′ further comprises an exterior side front face 70a integrally formed on the exterior side piece 50c and a plurality of engaging pieces 70b′ formed by cutting out the interior side front face integrally formed on the interior side piece 50b. A part between the exterior side plane 70a and the plurality of engaging projecting pieces 70b′ defines a guide groove 80 for receiving an end portion in the width direction of the shutter curtain 4.

An interior side cutout recessed part 90 is formed between the engaging projecting pieces 70b′ arranged lined up in the vertical direction. The engaging projecting piece 70b′ comprises a horizontal edge 900, a vertical edge 902 extending upward from the end of the lower edge 900, and a diagonal edge 901 extending from the upper end of the vertical edge 902 toward the interior side piece 50b in a tilted manner. As for the engaging projecting pieces 70b′ located adjacent to each other in the vertical direction, a space between the lower edge 900 of the upper engaging projecting piece 70b′ and the tilted edge 901 of the lower engaging projecting piece 70b′ forms an interior side cutout recessed part 90, and the lower edge of the upper engaging projecting piece 70b′ constitutes the upper edge 900 of the cutout recessed part 90 which constitutes an engaging portion.

FIG. 18 is a diagram corresponding to FIG. 9, in which the left drawing corresponds to a normal situation, while the right drawing corresponds to when the bottom plate is lifted. In a fully closed state, the tilted lower edge 901 of the lower cutout recessed part 90 is located slightly above the connection portion 3′ of the bottom plate 6 and the slat 3, and the upper edge 900 of the cutout recessed part 90 is formed above by a predetermined distance from the position opposed to the connection portion 3′ of the bottom plate 6 and slat 3. The interior side plane portion 7b of the outer guide rail 5 is cutout in the lower portion thereof which contains the entire height of the hook member 50′, together with the distal end on the opening section side of the interior side piece 5b, and an interior side cutout recessed part 90A is formed. A deformable cover 110 is provided to cover the interior side cutout recessed part 90A and the plurality of cutout recesses 90 formed on the hook member 50′. The cover 110 serves to function as a guide for preventing the bottom plate 6 from inclining and the connection portion 3′ of the bottom plate 6 and the slat 3 from being engaged by the upper edge 900 in normal ascending of the shutter curtain. The cover 110 also serves to conceal the hook member 50′. In normal ascending and descending operation of the shutter curtain, the shutter curtain 4 is guided by the cover 110 so that the bottom plate 6 does not go into the cutout recessed part 90 and incline, and the connection portion 3′ of the bottom plate 6 and the slat 3 is not engaged by the upper edge 900 of the interior side cutout recessed part 90. When the bottom plate 6 is lifted while the opening section is kept fully closed, the bottom plate 6 inclines causing the cover 110 to spread out toward the interior side, and simultaneously the connection portion 3′ of the bottom plate 6 and the slat 3 goes into the cutout recessed part 90 formed in the hook member 50′ and is engaged by the upper edge 900 of the recess 90. Although FIG. 18 shows a state in which the connection portion 3′ of the bottom plate 6 and the slat 3 is engaged by the lowest cutout recessed part 90, even in a case where the connection portion 3′ is not engaged by the lowest cutout recessed part 90, engagement of the connection portion 3′ by any of the upper cutout recesses 90 enables more reliable prevention of the bottom plate 6 from being lifted. The A-A cross sectional view, B-B cross sectional view, and C-C cross sectional view in FIG. 18 are the same as the respective cross sectional views in FIG. 16. Although the structure in which an exterior side cutout recess is not provided is shown in FIGS. 18 and 19, an exterior side cutout recess may be provided as shown in FIG. 9, for example.

### Eighth Embodiment

In the eighth embodiment, lifting of a shutter in a closed state can be prevented using a simple structure in which hardware having an engaging prong formed thereon so as not to project into the guide groove is provided inside the guide rail.

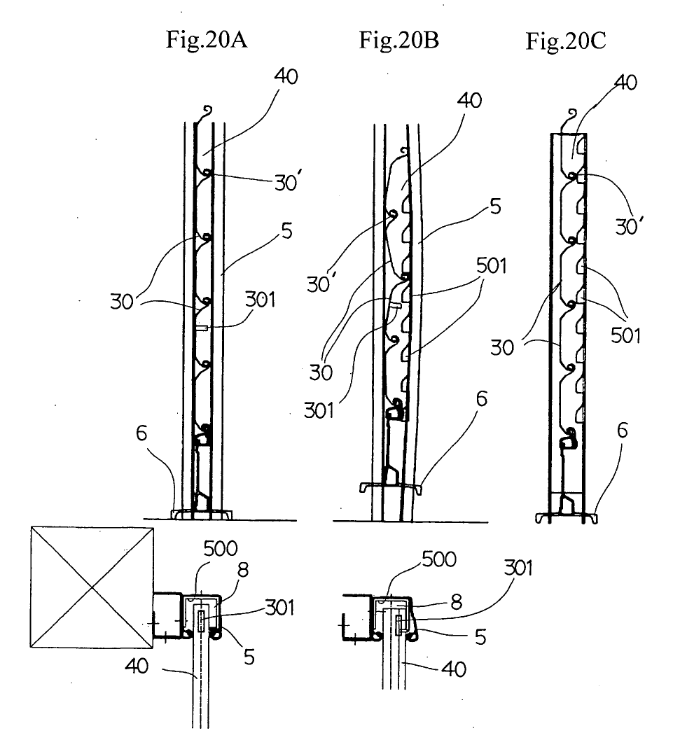

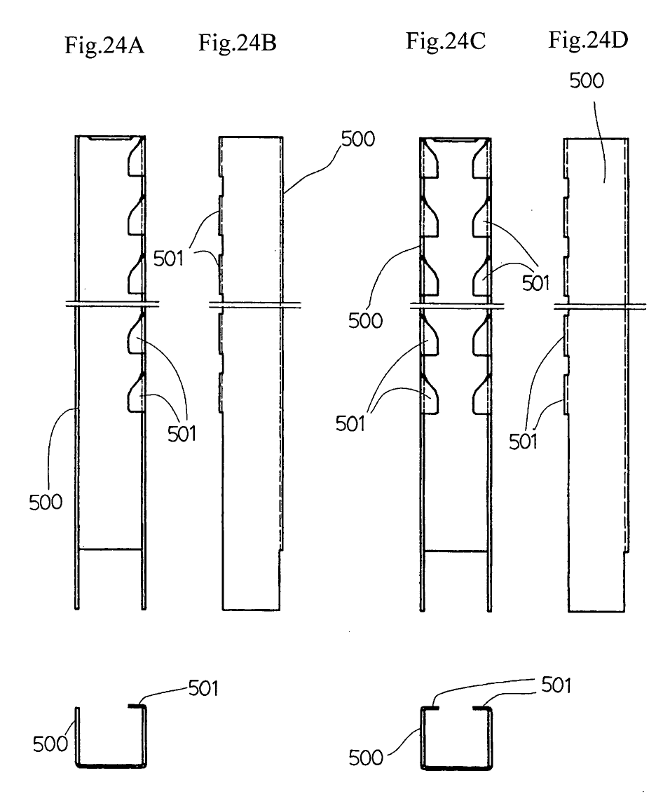

In FIGS. 20 through 25, 40 refers to a slat curtain in which slats 30 are connected in the vertical direction via an interlock portion 30, and the slat curtain 40 is constructed so as to be guided, while being wound around the winding drum, for ascending and descending by the guide rail 5 to thereby open and close the opening section. Whether the opening and closing operation is conducted either electrically or manually is not critical. In this case, as for a conventional electric shutter, a braking mechanism is provided relative to a motor for winding up the shutter curtain, and a means for fixing the curtain to the winding drum in the case is employed. However, as no blocking means against lifting is provided for the portion of the shutter curtain below the portion for which the fixing means is employed, even though braking control is effected for to the winding drum while the shutter is kept in a shut state, lifting the shutter curtain by grabbing the lower portion of the shutter curtain may cause slackening following the upward movement• •This results in a problem that opening may be allowed.

Also, as for a manual shutter, although a locking mechanism is provided by utilizing a guide rail in the middle portion of the opening section, as there is no blocking means provided for a portion of the shutter curtain below the locking mechanism, similar to the electric shutter, there is a problem that opening may be allowed.

The present invention is characterized in that, in consideration of the current situation, hardware having an engaging prong formed thereon so as not to project toward the guide groove is formed on either an inner or outer side of the guide rail 5. Although a U shape, which is identical to the guide rail 5, is shown in the embodiment, this is not a limited example, and an L-shape is applicable. The depth in the direction toward the rear wall 500a is set smaller than that of the rear wall 5a of the guide rail 5. Therefore, the opening edges of the interior side lateral wall 5b and exterior side lateral wall 5c of the guide rail 5 project more in the longitudinal direction of the guide groove 8 than the opening edges of the interior side lateral wall 500b and exterior side lateral wall 500c of the hardware 500.

The engaging prongs 501, 501 . . . are formed by cutting out at a predetermined interval on the interior side lateral wall 500b and exterior side lateral wall 500c of the hardware 500, so as to horizontally face, but not project into, the guide groove 8 of the guide rail 5. The engaging prongs 501, 501 . . . may be formed having an inverted L-shape in a side view by bending the front end thereof downward. The number of engaging prongs 501 is not particularly limited. The engaging prong 501 may be provided only on the interior side lateral wall 500b.

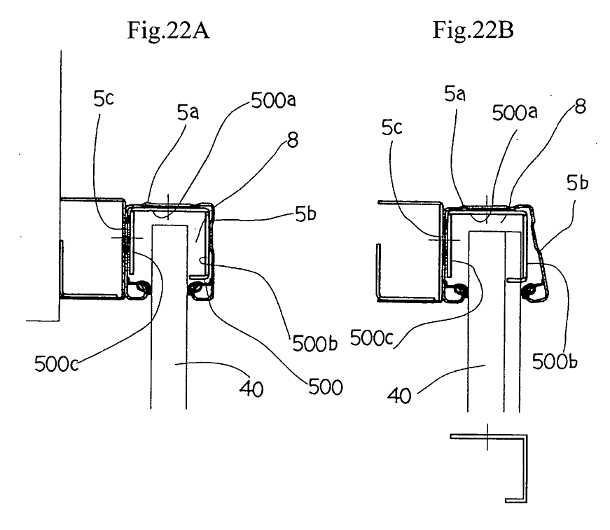

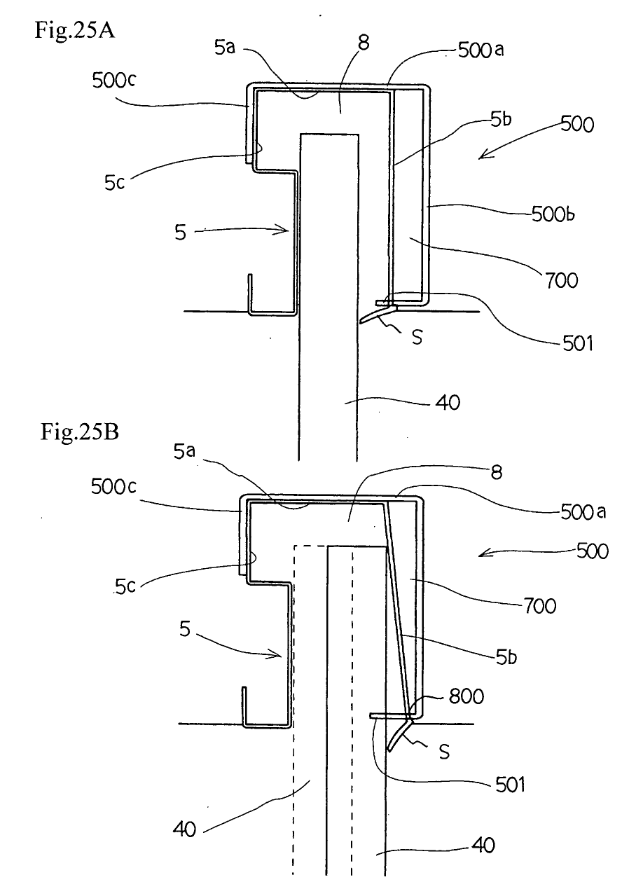

As for the hardware 500 provided outside the above-described guide rail 5, as shown in FIG. 25A, the exterior side lateral wall 500c located on the structure side is fixed to the exterior side lateral wall 5c of the guide rail 5, and the interior side lateral wall 500b faces into the interior side lateral wall 5b of the guide rail 5 via a vacant portion 700. A through hole 800 is formed by cutting out on the interior side lateral wall 5b at a position corresponding to the engaging prong 501. As for the hardware 500 provided inside the guide rail 5, the exterior side lateral wall 500c located on the body side is fixed to the exterior side lateral wall 5c of the guide rail 5, as shown in FIGS. 22A and 22B. The hardware 500 may connect between the rear walls 5a, 500a, in addition to, or in place of, between the exterior side lateral wall 500c and the exterior side lateral wall 5c of the guide rail 5. The fixing means for the hardware 500 and guide rail 5 is not limited. According to one aspect, the hardware 500 and guide rail 5 are fixed using a pin. When the hardware 500 is formed in an L shape, the rear wall 5a of the guide rail 5 and the rear wall 500a of the hardware 500 may be fixed to each other. It should be noted that S refers to an airtight member mounted to the opening end portion of the interior side lateral wall 5b of the guide rail 5.

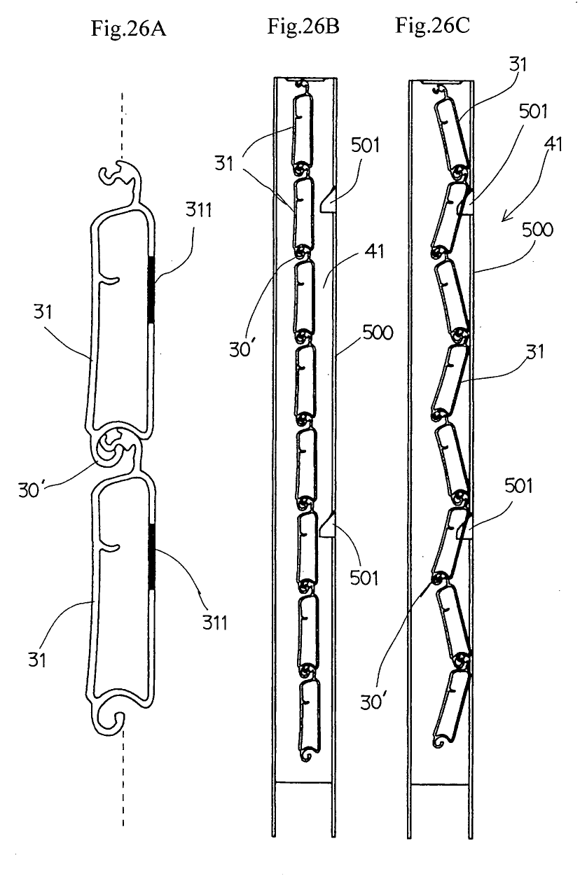

In FIGS. 26A through C, 41 refers to a hollow type slat curtain in which hollow type slats 31 are connected in the vertical direction via an interlock 30′. The hollow type slat curtain 41 is constructed so as to be guided, while being wound around the winding drum, for ascending and descending by the guide rail 5 to thereby open and close the opening section. Whether the opening and closing operation in this case is conducted electrically or manually is not critical. An engaging hole 311 is formed on the interior side (the rear surface side) of the hollow type slat 31, which is engaged by the engaging prong 501 of the hardware 500 when the bottom plate is lifted.

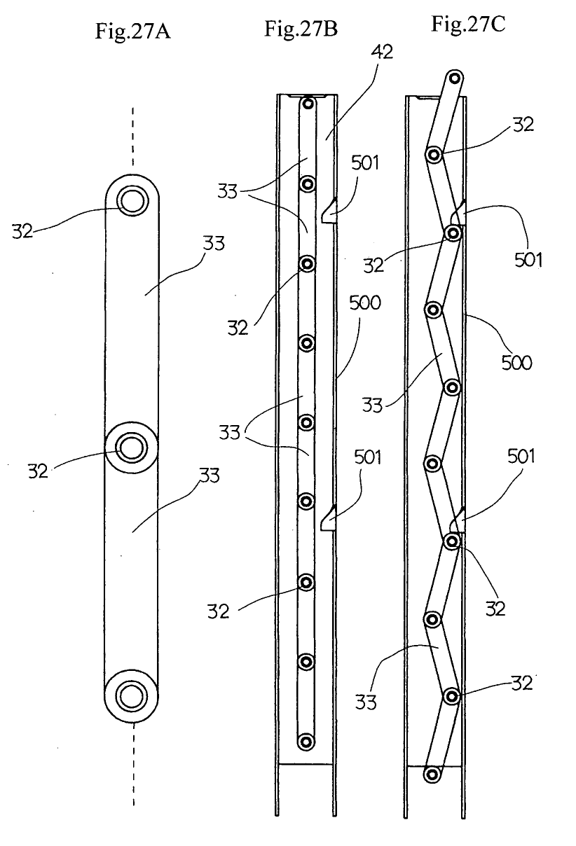

In FIGS. 27A through C, 42 refers to a pipe curtain in which a plurality of pipes 32 are connected to each other in the vertical direction via the link plate 33 at a predetermined interval. The pipe curtain 42 is constructed so as to be guided, while being wound around the winding drum, for ascending and descending by the guide rail 5 to thereby open and close the opening section. Whether the opening and closing operation in this case is conducted electrically or manually is not critical.

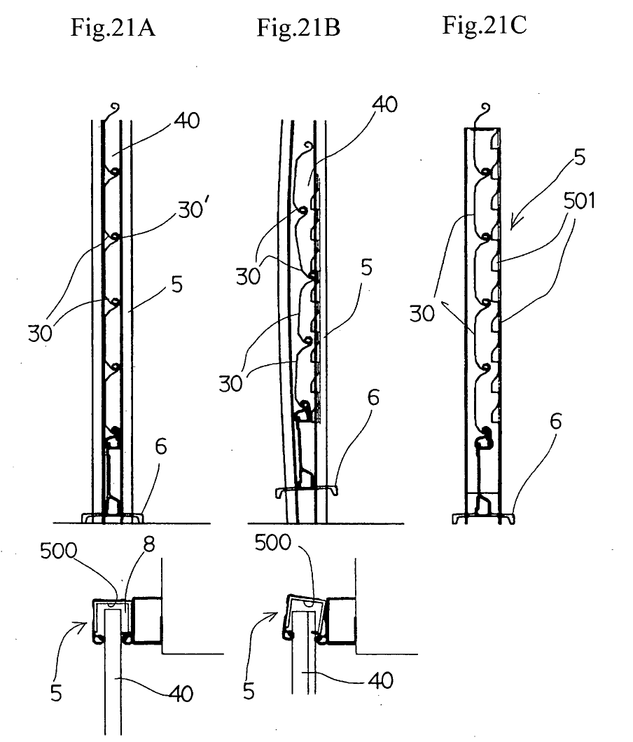

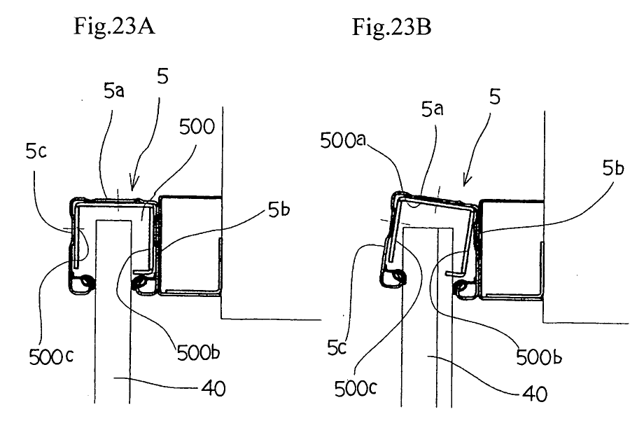

As the present invention is constructed as described above, when the shutter curtain of the shutter kept in a closed state is lifted from the lower surface of the bottom plate 6 using a tool such as a crowbar, the shutter curtain is vent at an interlock 3 in the case of a slat curtain 40 and a hollow type curtain 41, and at the link plate 9 in the case of a pipe curtain 42, accordingly, as shown in FIGS. 20B and 22B, thus causing the interior side lateral wall 5b of the guide rail 5 to be pressed and thereby spread out. This expansion causes the interlock 30′ in the case of the slat curtain 40, and an engaging hole 311 formed on the hollow type slat 31 in the case of a hollow type slat curtain 41, to be engaged by the engaging prong 501 formed on the interior side lateral wall 500b of the hardware 500, respectively, thus enabling prevention opening of the shutter curtain. In the embodiments shown in FIGS. 21B and 23B, as the hardware 500 and guide rail 5 are integrated, when the shutter curtain is lifted, the hardware 500 and guide rail 5 are caused to deform so as to incline with the fixed portion serving as a fulcrum and are engaged by the engaging prong 501 formed on the exterior side lateral wall 500c of the hardware 500. It should be noted that, as for a slat shutter, when a bar-like engaging piece 301 is formed on the end portion of the slat, as shown in FIG. 20B, the hardware 500 and guide rail 5 may be engaged by the engaging piece 301, instead of the interlock 30′. According to the present invention, it is possible to secure a crime prevention effect while significantly improving the crime prevention characteristics. Moreover, the structure is quite simple without the need to worry about breakdown, and adapted to post-attachment to an existing shutter.

Next, a mechanism for preventing an end portion of the slat 30 from coming off the guide rail 5 will be described. As for a basic structure of a shutter device, the above description can be referred to. According to one aspect, while an engaging projection portion 180 is formed on the lateral wall 5b located on the interior side B of the opposing lateral walls 5b, 5c of the guide groove 8, an engaging hook 100 which is an engaging piece 190 located so as to be opposed to the engaging projection portion 180 is fixedly attached to the interior side surface 30b of the end portion of each of the respective slats 30 located inside the guide groove 8. When an external force is applied from the exterior side A to the inside of the guide groove 8, the engaging piece 190 of the engaging hook 100 is deformed as the end portion of the slat deforms, and thus engaged by the engaging projection portion 180.

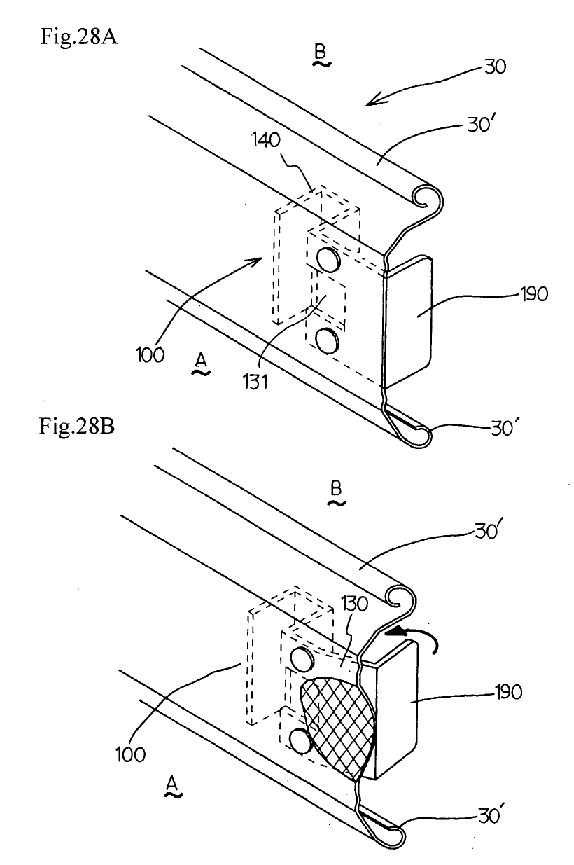

In FIGS. 28 through 30, an engaging projection portion 180 is formed in the entire region covering the entire height of the opening on the lateral wall 5b located on the interior side B, and a similar engaging projection portion 181 is formed on the lateral wall 5c located on the external side A. Alternatively, the engaging projection portion 180 may be provided not over the entire region at the height of the opening, but in a region at a minimum height corresponding to that of a person.

An engaging hook 100 is provided to the interior side surface 30b on the right and left end portions of each of the slats 30 located in the guide groove 8, and the engaging piece 190 of the engaging hook is located opposed to the engaging projection portion 180 of the guide rail 5. The engaging hook 100 is provided to the slat 30 so as not to project from the end of the slat 30 while substantially remaining within the width D of the slat 30. This arrangement prevents the engaging hook 100 from adversely affecting the winding or opening and closing operation in normal opening and closing operation of the shutter curtain 4 or when the shutter curtain 4 is wound around the winding drum. The engaging portion of the present invention is not limited to the one separately provided such as the above-described engaging hook 100, an engaging portion which is formed integrally by bending the end portion of the slat 30 may be applicable.

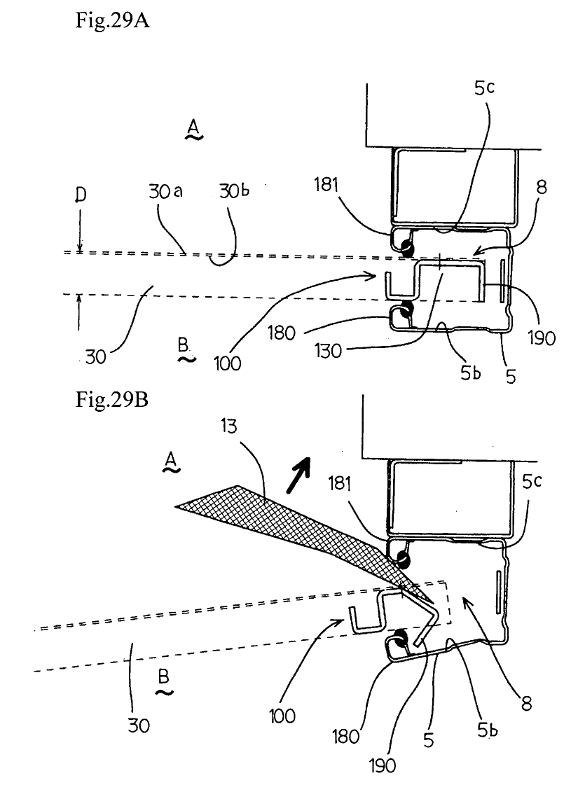

The engaging hook 100 has an L-shape in a plan view, formed by the main body plane 101 and the engaging piece 190 formed by bending one end of the main body plane, and is fixed to the interior side surface 30b at both ends of the slat 30 via the main body plane 101 using a screw. The main body plane 101 has a rectangular cutout 131 formed thereon, forming a low rigidity plane 130 with reduced rigidity compared to that of the other portions in a region covering from the inside of the surface containing the mounting position to the engaging piece 190. The engaging hook 100 is formed such that the entirety of the hook 100 remains within the width of the slat 30 indicated by the dot line in FIG. 29A. On the engaging piece 190, a reinforcing rib portion 140 having a U-shape in a plan view is formed integrally adjacent to the low rigidity plane 130.

When a crowbar 13 or the like is inserted into a small space formed between the guide groove 8 of the guide rail 5 and the end portion of the slat 30 while the shutter curtain 1 remains in a fully closed state, to scrape out the end portion of the slat within the guide groove 8, as shown in FIG. 29B, the exterior side surface 30a of the slat 30 starts deforming (a portion with crossing diagonal lines) due to the crowbar 13, beginning with the end of the slat 30 thereof, as shown in FIG. 28B. The deforming force is applied to the interior side surface 30b, that is, the mounting portion of the engaging hook 100. At the same time, the deforming force due to the crowbar 13 is applied to the engaging piece 190 of the engaging hook 100 with the engaging projection portion 181 of the lateral wall 5c located on the exterior side A serving as a fulcrum. This causes the lateral wall 5b located on the interior side B to deform and expand. Accordingly, the engaging piece 190 is deformed so as to project largely from the slat width D via the low rigidity plane 130 of the engaging hook 100, and an end thereof deforms so as to get closer to the exterior side engaging projection portion 180, as shown in FIG. 29B. When an external force is further applied by the crowbar 13 in the direction indicated by the arrow, an end of the engaging piece 190 is brought into engagement with the engaging projecting portion 180, as a result of which the end portion of the slat 30 is prevented from coming off from the guide groove 8.

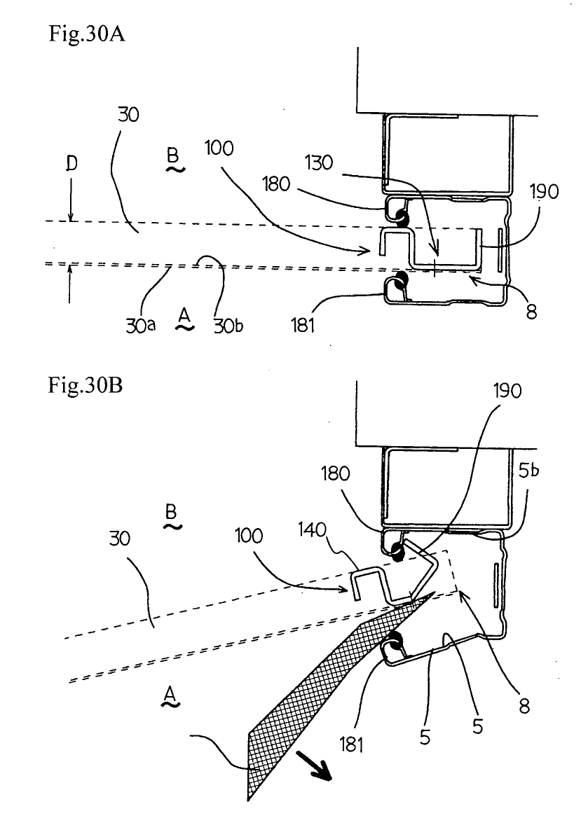

In the shutter device shown in FIG. 29, a guide rail 5 is formed on the side wall located on the interior side B of the building structure where the opening section of the building is formed. Alternatively, as shown in FIG. 30, when the guide rail 5 is formed on the side wall formed on the exterior side A of the structure where the opening section of the building is formed, the end of the slat 30 can be similarly prevented from coming off.

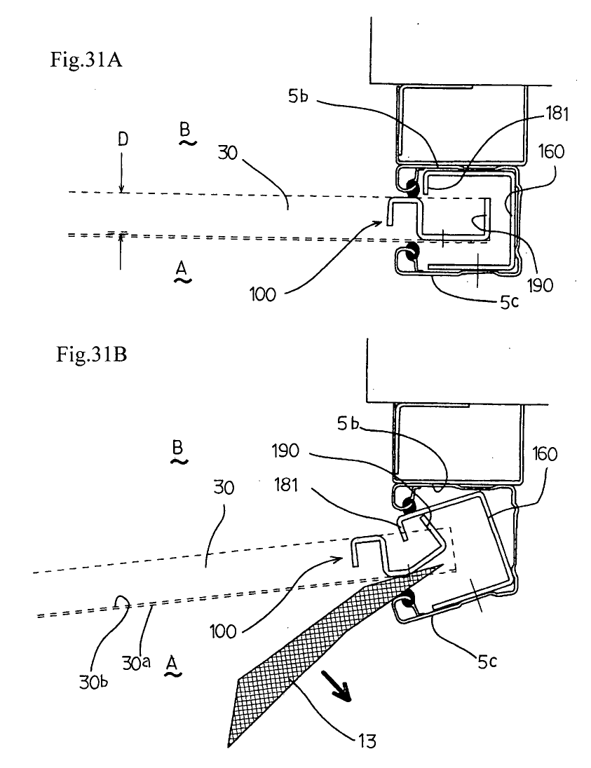

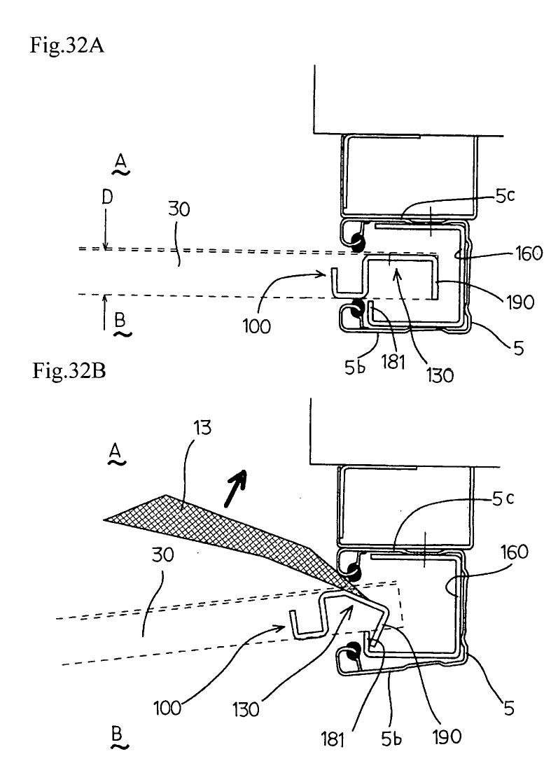

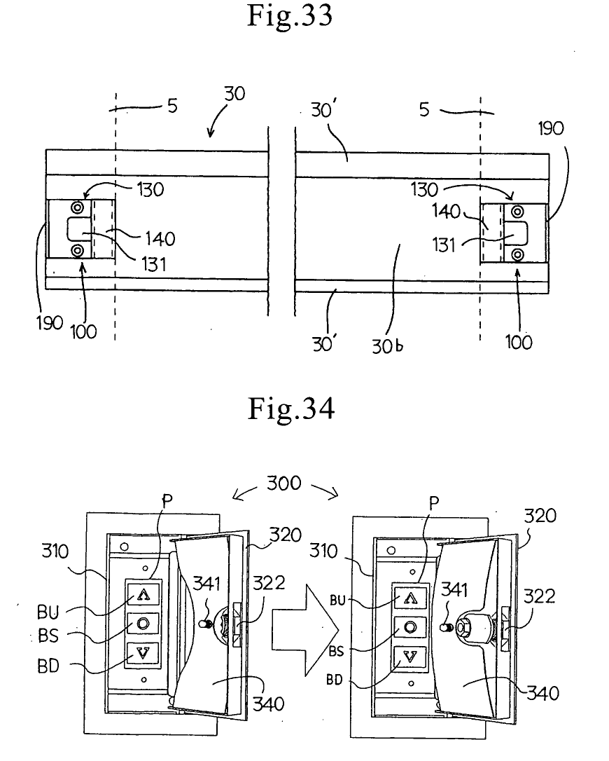

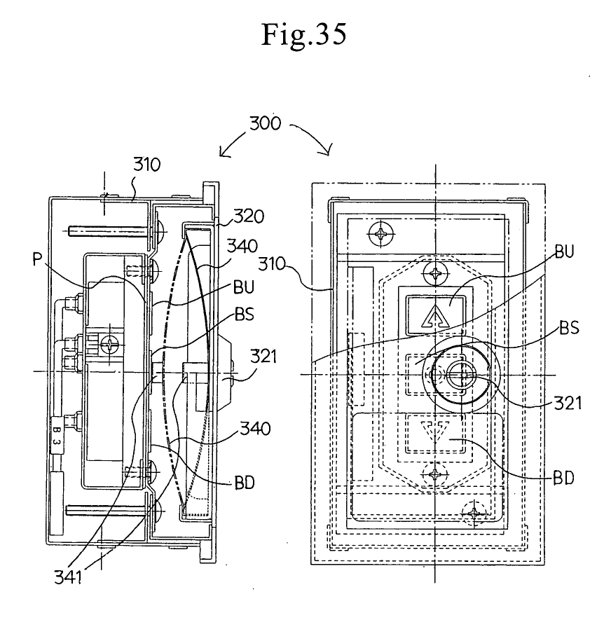

FIGS. 31 and 32 show another aspect of a crime prevention structure, in which a reinforcing guide portion 160 having an engaging projecting portion 181 formed integrally thereon so as to project from the inside of the lateral wall on the interior side of the guide rail 5 toward the slat surface, is fitted inside the guide rail 5, and an engaging portion 190 which is opposed to the engaging projecting portion 181 is formed on the interior side surface of the end portion of the slat located within the guide groove 8. With the above, when an external force is applied from the exterior side relative to the shutter curtain kept in a fully closed state in the direction of the inside of the surface of the end portion of the slat, the engaging piece 190 is deformed and engaged by the engaging projecting portion 181 of the reinforcing guide portion 160.

As shown in FIG. 31A, within the guide rail 5, a reinforcing guide portion having a substantially U shape in a cross sectional view and an engaging projection portion 181 formed thereon is formed along the inner surface of the lateral wall 5b located on the interior side B of the opposing lateral walls 5b, 5c of the guide groove 8, over a region covering the entire height of the opening section or a region between the lower end level of the guide rail 5 and the level of 1 m to 1.5 m above. The reinforcing guide portion is fixed to the lateral wall 5c on the exterior side of the guide rail 5. With the reinforcing guide portion 160 fitted inside the guide rail 5, the engaging projection portion 181 is formed so as to result in a height which forms a surface of substantially the same height and does not cause a problem when the slate 30 is guided by the guide groove 8. The engaging piece 190 of the engaging hook 100 is provided closer to the lower surface side of the guide rail 5 than the position of the engaging projection portion 181. Here, as shown in FIG. 31B, when an external force of the crowbar 13 which advances from the exterior side A into inside the guide groove 8 relative to the shutter curtain 4 kept in a fully closed state is applied to the direction of the inside of the surface of the end portion of the slat 30, the reinforcing guide portion 160 rotates in the horizontal direction within the guide rail 5, together with the deformation and expansion of the lateral wall 5c located on the external side A of the guide rail 5. As a result, the engaging piece 190 of the engaging hook 100 which is deformed via the low rigidity plane 130 projects largely from the slat width D, so that an end thereof is engaged by the engaging projecting portion 181 of the reinforcing guide portion 160.

With the above-described structure, as the external force due to the crowbar 13 is always applied to both of the reinforcing guide portion 160 and the engaging hook 100, the relative positional relationship thereof remains substantially constant. This enables more reliable engagement of the engaging hook 100 by the engaging projecting portion 181. The reinforcing guide portion 160 may be formed having an L shape in a cross sectional view.

In FIG. 31, a guide rail 5 is formed on a side wall located on the interior side B of the structure where the opening section of the construction is formed. FIG. 32 shows a guide rail 5 formed on the side wall located on the exterior side A of the body where an opening section of the construction is formed. Similar to that shown in FIG. 31, the guide rail 4 shown in FIG. 32 can also prevent the end portion of the slat 30 from coming off from the guide groove 8. Also, by providing a reinforcing guide portion 160 on the right and left guide rails 5, the reinforcing guide portion 160 can restrict deformation of the guide rail 5. This can prevent the slat 30 from easily coming off from the guide rail 5 due to deformation of the guide rail 5.

In the above-described crime prevention structure, when a crowbar or the like is pushed into the guide groove and bent, to thereby deform the right and left end portions of the shutter curtain which are inserted in the guide groove, the engaging piece of the engaging hook provided on the slat end portion is readily deformed due to the deformation via the low rigidity plane portion which allows deformation due to an external force. As the external force increases, the amount of deformation of the above-described engaging piece increases. This increases the strength of the engagement by the engaging projection portion on the guide rail side. As a result, coming off of the right and left ends of the shutter curtain becomes more unlikely to occur, and therefore, a higher crime prevention function can be maintained.

Next, a structure of a switch box which is superior in crime prevention function will be described. A shutter operational switch box 300 comprises a box portion 310, a press button switch formed on a plate P accommodated in the box portion 310, and a lid body 320 for opening and closing the opening section of the box portion 310. A key hole 321 is formed on the lid body 320. By inserting a key, not shown, into the key hole 321 to rotate the engaging piece 322 of the lid body 320, the lid body 320 can be opened. With the lid body 320 opened, operation of the press button switch is allowed. The press button switch comprises three buttons including an open button BU, a stop button BS, and a closing button BD. The stop button BS is located substantially in the middle in terms of height of the switch box 300. These buttons are electrically connected to a shutter opening and closing unit. Recently, crimes have been committed where the lid body 320 is drilled to make a hole, and the open button BU is pressed while utilizing the hole to thereby lift the shutter curtain so as to allow intrusion into the interior. Here, a switch box having a structure which does not allow the shutter to be opened even when the lid body is drilled, instead of opening the lid body of the shutter, is described.

The crime prevention structure employed here is such that, in a switch box having a lid body 320 and a press button switch provided inside thereof, a plate spring member is provided between the rear surface of the lid body 320 and the press button switch. When a force is applied from the lid body side, the spring member expands toward the press button switch side to thereby press the stop button of the press button switch. In the shutter device, a signal is not sent to the motor of the opening and closing machine during a period in which the stop button is kept pressed even though the open button is pressed. Therefore, the shutter cannot be opened.

On the rear surface side of the lid body 320, a flat plate-shaped spring member 340 is attached with the upper and lower ends thereof being supported. A distance between the upper and lower supporting points of the spring member 340 is smaller than the height of the plate spring member 340, and the spring member 340 is supported between the upper and lower supporting points while bending like a bow with the upper and lower supporting points serving as fulcrums. The spring member 340 is mounted to the lid body 320 such that the upper and lower supporting points (upper and lower ends) of the spring member 340 are located apart to the rear (on the press button switch side) from the rear surface of the lid body 320, and a space is formed between the spring member 340 and the rear surface of the lid body 320. In a normal situation, the spring member 340 is mounted to the lid body 320 in a state of expanding toward the lid body 320, while utilizing the space with the upper and lower supporting points (upper and lower ends) serving as fulcrums.

Meanwhile, a space is formed between the spring member 340 and the press button switch, for allowing the spring member 340 to expand toward the press button switch side. The spring member 340 is fixed on the upper and lower ends thereof. When a force toward the press button switch is applied from the lid body to the spring member 340 when the spring member 340 is kept in a state of expanding like a bow toward the rear surface of the main body 30 of the lid body 320, the spring member 340 is reversed by the force with the upper and lower supporting points serving as fulcrums, and then expands toward the press button switch. As a result, the spring member 340 is left in a state in which the middle portion thereof in the height direction (the vertical direction) is expanded most toward the press button switch, with the most expanded portion being opposed to the stop button BS of the press button switch. On the middle portion in the height direction of the spring member 340 (that is, a most expanding portion), a pressing projection portion 341, which projects toward the press button switch (the stop button BS) side, is formed. As the spring member 340 expands towards the press button switch side, the pressing projection portion 341 presses the stop button BS to thereby shut down the opening and closing driving circuit. Even if the open button BU is pressed in this state, it is not possible to lift the shutter curtain. The pressing projection portion 341 is set at such a height that the pressing projection portion 341 does not abut on the stop button BS in a normal situation in which the spring member 340 projects toward the rear surface of the lid body.

The spring member 340 is a plate having a substantially longitudinal rectangular shape, and mounted to cover substantially the entire surface of the lid body 320 while a cutout is formed on the middle portion in the height direction as to avoid the key portion formed on the lid body 320. Therefore, even if the lid body 320 is drilled from the outside at any part thereof, the tip end of the drill resultantly abuts on the spring member 340. Accordingly, a force directing the press button switch is applied to the spring member 340, and the spring member 340 is reversed with the upper and lower end portions serving as fulcrums, expanding towards the press button switch side. Preferably, the spring member 340 is a metal plate spring which is made using plate spring steel or the like. However, a spring member which is made using any material such as resin other than metal is applicable as long as predetermined strength and elasticity are ensured.

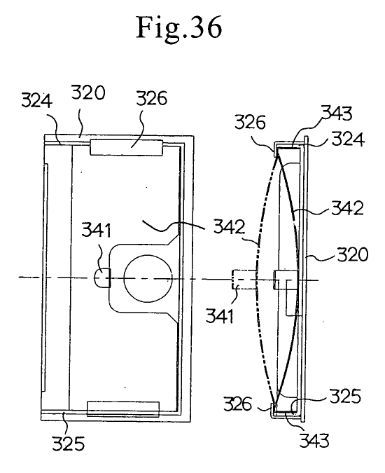

A structure for mounting the spring member 340 and lid body 320 will be described based on FIG. 36. According to a preferred aspect, the plate spring member 340 comprises a spring member main body which is deformable into a bow like shape and a mounting piece 343 formed integrally on the upper and lower ends of the main body 342. The plate spring member 340 is mounted to the lid body 320 by having the mounting pieces 343 engaged by the engaging pieces 326 formed on the upper end piece 324 and lower end piece 325 of the lid body 320. The plate spring member 340 can bend toward the lid body 320 side and the press button switch side, respectively, with the upper and lower ends of the main body 342 serving as fulcrums. When a force directing the press button switch is applied to the spring member 340 which is kept in a state of expanding toward the lid body side, the main body 342 is reversed with the upper and lower ends thereof serving as fulcrums into a posture in which the main body 342 expands towards the press button switch side. It can be readily understood by a person skilled in the art that a variety of structures can be employed for mounting the plate spring member 340 and the lid body 320, and that a structure for mounting a plate spring member is not limited to the one shown.

When the switch box 300 is drilled directly on the lid body 320 thereof, upon completion of the drilling to form a hole on the lid body 320, the tip end of the drill is brought to abut on the spring member 340 which is located on the rear side of the lid body 320 and kept bending like a bow, and a force directing the press button switch side is applied to the spring member 340. The force causes the spring member 340 to bend backwards and thereby expand towards the stop switch BS, as a result of which the pressing projection portion 341 mounted on the spring member 340 presses the stop switch BS to shut down the shutter opening and closing driving circuit. Further, even if the open button is pressed by drilling, it is not possible to lift the shutter curtain while the stop switch BS is kept pressed. Also, the spring member 340 serves to let the tip end of the drill escape while drilling. That is, the tip end of the drill resultantly abuts on the spring member in an inclining manner, and the tip end escapes, which makes it difficult to make a hole. Also, when a spring member is made using a spring steel, the tip end of the drill is pressed hard onto the spring steel in order to make a hole, as the material of the spring member is rigid. In this case, the spring steel is caused by the pressing force to expand toward the press button side and thereby press the stop button. Even with a switch box 300 having a lid body 320 where a hole is made by drilling, when the lid body 320 is opened using a key, the spring member 340 formed on the lid body side rotates together with the lid body 320, and pressing of the stop button BS by the pressing projection portion 341 of the spring member 340 is released. This allows normal opening and closing operation. Restoration of the spring member 340 to its original condition can be attained by only releasing the lid body to thereby press the spring member 340 to expand toward the lid side. Also, as for a switch box already installed, by exchanging the box 310 and lid body 320 thereof, a switch box 300 of the present invention can be constructed. Although the spring member can be mounted on the box portion side of the switch box, according to a preferred aspect, the spring member is mounted to the lid body.

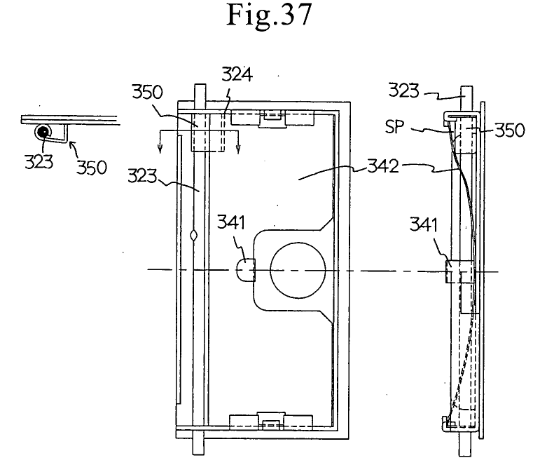

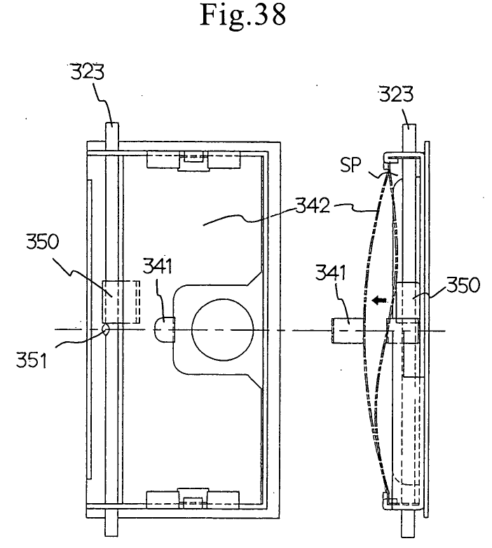

FIG. 37 and FIG. 38 relate to a mechanism in which a spacer is provided for preventing the spring member 340 which projects toward the press button switch side and presses the stop button BS from restoring to its original position on the lid side so that the pressing of the stop button BS is not released. FIG. 37 shows a normal situation in which the spring member 340 remains like a bow with the middle portion thereof in the vertical direction expanding toward the lid body side, with the upper and lower ends serving as supporting points. The upper and lower ends of the spring member 340 remain apart from the rear surface of the lid body, and a space SP is formed between the rear surface of the lid body and the upper portion of the spring member 340. The space SP is defined by the rear surface of the lid main body, the upper side piece 324 of the lid body, and the plane portion of the upper portion of the spring member 340 which extends diagonally downward from the press button switch side to the lid body side. With the tilting plane portion of the spring member 340, the space SP is formed so as to be narrower from the upper to lower portions thereof. In a normal situation, a spacer 350 is provided in the space SP with the lower end of the spacer 350 abutting, and held by, the plane portion of the tilted spring member 340. Specifically, the spacer 350 is a member having a square shape in a front side view and a substantially L-shape in a cross sectional view and provided to the rotation axis 323 of the lid body so as to freely move in the vertical direction. As described above, as the lower end of the spacer 350 abuts on the tilted spring member 340, the spacer 350 is prevented from dropping.

In the state shown in FIG. 37, when the spring member 340 expands toward the press button switch side, the tilted upper portion of the spring member 340 moves towards the press button switch side, and an enlarged space SP results. With an enlarged space SP, the spacer 350 loses support from the tilted plane of the spring member 340, and therefore moves downward along the rotation axis 323 due to its own weight. A stopper 351 is provided in the middle portion in the vertical direction of the rotation axis 323 (the middle portion in the vertical direction of the spring member 10). With the stopper 351 abutting on the spacer 350, further downward movement of the spacer 350 is restricted. Therefore, while the spring member 340 expands towards the press button switch side and thereby presses the stop button BS, the spacer 350 is located on the rear surface side (a lid body side) of the middle portion in the vertical direction and the vicinity thereof (the upper portion side of the middle portion in the drawing). In this state, even if the spring member 340 is restored to its original position, as the plane portion of the spring member 340 abuts on the spacer 350, the spring member 340 cannot expand towards the lid body side. As a result, the spring member 340 automatically expands again towards the press button, and the pressing projection portion 341 accordingly presses the stop button BS. A spacer prevents the most expanding portion of the middle portion in the vertical direction of the spring member 10 from moving further toward the lid body rear surface side while exceeding the line connecting the upper and lower ends of the spring member. The shape and structure of a spacer 350 are not limited to those shown.

### INDUSTRIAL APPLICABILITY

The crime prevention mechanism according to the present invention is applied to a shutter in which a shutter curtain which comprises a plurality of curtain pieces connected in the vertical direction is guided for ascending and descending by a guide rail to thereby open and close a opening section without discrimination between heavy and light weight shutters and electric and manual shutters.

1. A shutter curtain lifting prevention structure comprising:
a shutter curtain being comprised of a plurality of curtain pieces connected in a bendable manner;
guide rails along which edges of the shutter curtain being guided for ascending and descending to thereby open and close an opening; and
an engaging portion being provided on the guide rail so as not to block normal opening and closing of the shutter curtain, such that when the shutter curtain kept in a shut state is lifted from the lower surface of a bottom plate, one or more curtain pieces of at least a part of shutter curtain in a vertical posture are bent, whereby a part of the bent curtain piece is caused to be engaged by the engaging portion.

2. The structure of claim 1, wherein said curtain piece is a slat and a plurality of slats are connected via an interlock portion to constitute the shutter curtain, and wherein said part of the curtain piece which is engaged by the engagement portion is the interlock portion.

3. The structure of claim 2, wherein the interlock portion which is engaged by the engagement portion is an interlock portion for connecting the bottom plate and the slat, and wherein the engaging portion is a cutout recess formed in an interior side portion of the guide rail in the vicinity of the floor surface.

4. The structure of claim 1, said structure further comprising hardware provided on the inner or outer side of the guide rail, wherein the engaging portion provided on the guide rail is an engaging prong which is formed so as not to project toward the guide groove, on at least an interior side wall of said hardware, and wherein pressing by the bent curtain pieces causes the interior or exterior side wall of the guide rail to expand, thus causing the curtain piece to be engaged by the engaging prong.

5. A shutter curtain lifting prevention structure comprising:
a shutter curtain formed by connecting a plurality of slats via an interlock portion in the vertical direction;
guide rails standing on both sides of an opening of the construction, by which both edges of said shutter curtain being guided for ascending and descending to thereby open and close an opening of the construction; and
a cutout recess being integrally formed at the guide groove of each guide rail, said cutout recess being formed by horizontally cutting out the interior side plane portion of the front face located above and in the vicinity of the floor surface, such that when a bottom plate of the shutter curtain kept in a shut state is lifted, a connection portion of the bottom plate and the slat, which is opposed to the cutout recess is made engaged by the engaging portion defined by the cutout recess, thus preventing lifting of the shutter curtain.

6. A shutter curtain lifting prevention structure comprising:
a shutter curtain formed by connecting a plurality of slats via an interlock portion in the vertical direction;
guide rails standing on both sides of an opening of the construction, by which both edges of said shutter curtain being guided for ascending and descending to thereby open and close an opening of the construction;
a guide groove of the guide rail being formed between the interior side plane portion and exterior side plane portion of each guide rail; and
an interior side cutout recess being formed on the interior side plane portion, said interior side cutout recess having an engagement portion located at a position higher than the connection portion of a bottom plate and the slat of the shutter curtain kept in a fully closed state, such that when the bottom plate of the shutter curtain kept in a fully closed state is lifted from the exterior side, the bottom plate inclines and the connection portion is thereby caused to be engaged by the engaging portion of the interior side cutout recess, thus preventing lifting of the shutter curtain.

7. The structure of claim 6, said structure further comprising an exterior side cutout recess being formed on the exterior side plane portion so as to be opposed to the bottom plate of the shutter curtain kept in a fully closed state, such that when the bottom plate of the shutter curtain kept in a fully closed state is lifted from the exterior side, the bottom plate inclines with the lower end side thereof moving toward the exterior side via the exterior side cutout recess, and the connection portion is thereby caused to be engaged with the engagement portion of the interior side cutout recess, thus preventing lifting of the shutter curtain.

8. A shutter curtain lifting prevention structure comprising:
a shutter curtain formed by connecting a plurality of slats via an interlock portion in the vertical direction;
guide rails standing on both sides of an opening of the construction, by which both edges of said shutter curtain being guided for ascending and descending to thereby open and close an opening of the construction;
a guide groove of the guide rail being formed between the interior side plane portion and exterior side plane portion of each guide rail;
an inner space of the guide rail being defined by the guide groove for receiving an edge portion of the shutter curtain, an interior side space of the guide groove, and an exterior side space of the guide groove;
an intra-rail hook member being provided in the interior side space of the inner space of the guide rail, said intra-rail hook member having an engaging portion located at a position higher than the position of the connection portion of the bottom plate and slat of the shutter curtain kept in fully closed state; and
an interior side cutout recess being formed on the interior side plane portion of the guide rail, said interior side cutout recess containing a portion opposed to the engaging portion of the intra-rail hook member, such that when the bottom plate of the shutter certain kept in a fully closed state is lifted from the exterior side, the bottom plate inclines and the connection portion is thereby caused to be engaged by the engaging portion of the intra-rail hook member, thus preventing lifting of the shutter curtain.

9. The structure of claim 8, said structure further comprising an exterior side cutout recess being formed on the exterior side plane portion of the guide rail, said exterior side cutout recess containing a portion opposed to the bottom plate of the shutter curtain kept in a fully closed state, such that when the bottom plate of the shutter curtain kept in a fully closed state is lifted from the exterior side, the bottom plate inclines with the lower end side thereof moving toward the exterior side via the exterior side cutout recess, and the connection portion is thereby caused to be engaged by the engagement portion, thus preventing lifting of the shutter curtain.

10. The structure of claim 5, said structure further comprising a deformable cover being provided at the cutout recess of the guide rail for closing the cutout recess, such that when the bottom plate of the shutter curtain kept in a fully closed state is lifted from the exterior side, the connection portion presses, and thereby deforms, the cover for the cutout recess to thereby cause the connection portion to be engaged by the engagement portion.

11. The structure of claim 5, said structure further comprising a rotatable cover being provided at the cutout recess of the guide rail for closing the cutout recess, such that when the bottom plate of the shutter curtain kept in a fully closed state is lifted from the exterior side, the connection portion presses, and thereby rotates, the cover for the cutout recess to thereby cause the connection portion to be engaged by the engagement portion.

12. The structure of claim 7, said structure further comprising an interior side deformable cover being provided at the interior side cutout recess of the guide rail for closing the interior side cutout recess and an exterior side deformable cover being provided at the exterior side cutout recess of the guide rail for closing the exterior side cutout recess, such that when the bottom plate of the shutter curtain kept in a state of fully closed is lifted from the exterior side, the lower end side of the bottom plate moves toward the exterior side while pressing, and thereby deforming, the exterior side cover and consequently inclines, so that the connection portion presses, and thereby deforms, the cover of the interior side cutout recess, as a result of which the connection portion is caused to be engaged by the engagement portion.

13. The structure of claim 7, said structure further comprising an interior side rotatable cover being provided at the interior side cutout recess of the guide rail for closing the interior side cutout recess and an exterior side rotatable cover being provided at the exterior side cutout recess of the guide rail for closing the exterior side cutout recess, such that when the bottom plate of the shutter curtain kept in a state of fully closed is lifted from the exterior side, the lower end side of the bottom plate moves toward the exterior side while pressing, and thereby rotating, the exterior side cover and consequently inclines, so that the connection portion presses, and thereby deforms, the cover of the interior side cutout recess, as a result of which the connection portion is caused to be engaged by the engagement portion.

14. The structure of claim 10, said structure further comprising a detection portion being provided in the vicinity of the cutout recess, for detecting deformation or rotation of the cover.

15. A shutter curtain lifting prevention structure comprising:
a shutter curtain being comprised of a plurality of curtain pieces connected in a bendable manner;
guide rails along which the edges of the shutter curtain being guided for ascending and descending along the guide rails to thereby open and close an opening section; and
hardware being provided on the inner or outer side of the guide rail, said hardware being provided with an engagement prong formed at least on the interior side lateral wall of said hardware so as not to project into the guide groove, such that when the shutter curtain is lifted from the lower surface of the bottom plate while the shutter is kept shut, pressing by the bent curtain pieces which are bent in association with the lifting causes the interior or exterior side lateral wall of the guide rail to expand, thus causing the curtain piece to be engaged by the engaging prong.

16. The structure of claim 15, wherein the curtain piece to be engaged by the engagement prong of the hardware is an interlock portion connecting the slat.

17. The structure of claim 6, said structure further comprising a deformable cover being provided at the cutout recess of the guide rail for closing the cutout recess, such that when the bottom plate of the shutter curtain kept in a fully closed state is lifted from the exterior side, the connection portion presses, and thereby deforms, the cover for the cutout recess to thereby cause the connection portion to be engaged by the engagement portion.

18. The structure of claim 8, said structure further comprising a deformable cover being provided at the cutout recess of the guide rail for closing the cutout recess, such that when the bottom plate of the shutter curtain kept in a fully closed state is lifted from the exterior side, the connection portion presses, and thereby deforms, the cover for the cutout recess to thereby cause the connection portion to be engaged by the engagement portion.

19. The structure of claim 6, said structure further comprising a rotatable cover being provided at the cutout recess of the guide rail for closing the cutout recess, such that when the bottom plate of the shutter curtain kept in a fully closed state is lifted from the exterior side, the connection portion presses, and thereby rotates, the cover for the cutout recess to thereby cause the connection portion to be engaged by the engagement portion.

20. The structure of claim 8, said structure further comprising a rotatable cover being provided at the cutout recess of the guide rail for closing the cutout recess, such that when the bottom plate of the shutter curtain kept in a fully closed state is lifted from the exterior side, the connection portion presses, and thereby rotates, the cover for the cutout recess to thereby cause the connection portion to be engaged by the engagement portion.

21. The structure of claim 9, said structure further comprising an interior side deformable cover being provided at the interior side cutout recess of the guide rail for closing the interior side cutout recess and an exterior side deformable cover being provided at the exterior side cutout recess of the guide rail for closing the exterior side cutout recess, such that when the bottom plate of the shutter curtain kept in a state of fully closed is lifted from the exterior side, the lower end side of the bottom plate moves toward the exterior side while pressing, and thereby deforming, the exterior side cover and consequently inclines, so that the connection portion presses, and thereby deforms, the cover of the interior side cutout recess, as a result of which the connection portion is caused to be engaged by the engagement portion.

22. The structure of claim 9, said structure further comprising an interior side rotatable cover being provided at the interior side cutout recess of the guide rail for closing the interior side cutout recess and an exterior side rotatable cover being provided at the exterior side cutout recess of the guide rail for closing the exterior side cutout recess, such that when the bottom plate of the shutter curtain kept in a state of fully closed is lifted from the exterior side, the lower end side of the bottom plate moves toward the exterior side while pressing, and thereby rotating, the exterior side cover and consequently inclines, so that the connection portion presses, and thereby deforms, the cover of the interior side cutout recess, as a result of which the connection portion is caused to be engaged by the engagement portion.
